(19) United States
(12) Patent Application Publication
(10) Pub. No.: US 2022/0361008 A1
(43) Pub. Date: Nov. 10, 2022

(54) TRAVERSABLE NETWORK-AWARE RADIO MODELING

(71) Applicant: HERE Global B.V., Eindhoven (NL)

(72) Inventors: Pavel Ivanov, Tampere (FI); Henri Jaakko Julius Nurminen, Tampere (FI); Marko Luomi, Lempaeaelae (FI); Lauri Aarne Johannes Wirola, Tampere (FI)

(21) Appl. No.: 17/302,556

(22) Filed: May 6, 2021

(51) Int. Cl. H04W 24/02; H04W 64/00

(52) U.S. Cl. CPC H04W 24/02; H04W 64/00

(57) ABSTRACT

A processor obtains a plurality of instances of access point observation information. Each instance of access point observation information comprises (a) radio observation information corresponding to observation of one or more access points by a respective mobile device and (b) location information comprising an indication of a location of the respective mobile device when the respective mobile device observed the one or more access points. For one or more instances of access point observation information, based at least on the location information of the instance and a digital map that is accessible to the at least one processor, the process identifies a respective (TME) of the digital map that represents a portion of a traversable network where the mobile device was located when the mobile device observed the one or more access points; and associates at least a portion of the radio observation information with the respective TME.

### TECHNOLOGICAL FIELD

An example embodiment relates to associating a network access point with a representation of traversable element of a traversable network. An example embodiment relates to generating and/or using a radio positioning map in which network access points are associated with representations of traversable elements of a traversable network and/or representations of buildings.

### BACKGROUND

In various scenarios, global navigation satellite system (GNSS)-based positioning is not available and/or accurate (e.g., indoors, in urban canyons, and/or the like). In such scenarios, radio-based positioning may be used. For example, a computing device may observe one or more network access points (e.g., cellular network access points, Wi-Fi network access points, Bluetooth network access points, and/or other radio frequency-based network access points) and, based on characteristics of the observations and the known location of the observed access points, a position estimate for the computing device may be determined.

However, in order to learn the locations of access points, probe data is often used. In order for such probe data to be useful in learning the location of an access point, the probe data should include an indication of observing the access point and a location estimate where the access point was observed. A number of access points are located indoors (e.g., within buildings), where GNSS-based positioning is not available and/or accurate. As such, the probe data with the most accurate and/or reliable location estimates tend to be captured outdoors (e.g., outside of buildings). Therefore, a problem exists as to how to use the data probes captured outdoors to create a radio model of a radio node located indoors.

### BRIEF SUMMARY

Various embodiments provide methods, apparatus, systems, and computer program products for associating radio observation information with a traversable map element (TME) of a digital map configured to represent a traversable network. Various embodiments provide methods, apparatus, systems, and computer program products for generating, providing and/or using a traversable network-aware positioning map and/or portions thereof that include an association and/or indication of an association between one or more access points and one or more respective TMEs, respective lateral sides of one or more respective TMEs, and/or respective representations of buildings.

In various embodiments, instances of radio observation information corresponding to a first access point are assigned to and/or associated with one or more respective TMEs of a digital map. In an example embodiment, an instance of radio observation information corresponding to the first access point is assigned to and/or associated with a TME of the digital map where a mobile device was located when the mobile device observed the first access point. Based on instances of radio observation information corresponding to the first access point and the respective TMEs that the instances of radio observation information are assigned to and/or associated with, the first access point is assigned to and/or associated with one or more respective TMEs and/or respective lateral sides of one or more respective TMEs. In various embodiments, a traversable network-aware positioning map is generated (e.g., created, updated, and/or the like) that comprises an indication of the first access point being assigned to and/or associated with one or more TMEs of the digital map and/or with a representation of a building of the digital map. For example, the digital map may comprise two-dimensional or three-dimensional representations of buildings associated with TMEs that respectively represent buildings located along the corresponding traversable elements of the traversable network. The traversable network-aware positioning map may then be used to determine positioning estimates of computing devices based on access points observed by the computing devices.

For example, one or more mobile devices may be onboard a vehicle traversing at least a portion of a traversable network (e.g., onboard a passenger car traversing at least a portion of a road network). As the mobile devise traverse at least a portion of the traversable network, the one or more mobile devices may capture and provide instances of access point observation information that includes radio observation information and location information. The radio observation information corresponds to the observation of one or more access points by the respective mobile device. In various embodiments, the radio observation information comprises a respective access point identifier for each of one or more access points observed by the mobile device. In various embodiments, a mobile device observes an access point by receiving, detecting, capturing, measuring, and/or the like a signal (e.g., a radio frequency signal) generated by the access point. For example, a mobile device may determine an access point identifier, a received signal strength, a time parameter (e.g., one-way or round trip time for communicating with the access point), a channel or frequency of the access point, and/or the like based on the mobile device's observation of the access point.

In various embodiments, an instance of access point observation information further comprises location information. In various embodiments, the location information comprises, a GNSS-based position estimate or other position estimate of the mobile device when the radio observation information was captured. The location information may comprise a highly-accurate GNSS-based position estimate and/or another position estimate and a direction of travel of the mobile device. In various embodiments, the position estimate is a GNSS-based position estimate, an inertial sensor and/or inertial measurement unit (IMU)-based position estimate, a magnetic and/or barometric pressure-sensor based position estimate, and/or a position estimate generated based at least in part on one or more sensors of the mobile device. Based on the location information, a TME and/or a lateral side of a TME of a digital map that the mobile device was located at and/or traversing when the mobile device observed the access point is determined. In various embodiments, a TME is representation of at least a portion of a road and/or path segment. For example, in various embodiments, a TME is a representation of a road and/or path (e.g., bike or pedestrian path) segment, a lane of a road and/or path, a set of lanes of a road and/or path segment having a common direction of travel (e.g., all of the lanes corresponding to the TME are configured to be traveled in the same direction), and/or the like. In various embodiments, a road and/or path segment is the segment of a road and/or path (e.g., bike and/or pedestrian path) defined by and/or disposed between two sequential intersections. For example a segment of a road and/or path does not include any intersections along its length but does start at an intersection and end at another intersection.

An instance of radio observation information is assigned to and/or associated with a TME and/or a lateral side of a TME based on the TME and/or lateral side of the TME determined for the corresponding instance of location information (e.g., the instance of location information included in the same instance of access point observation information as the instance of radio observation information). Based on a plurality of instances of observation information corresponding to a first access point (e.g., a plurality of instances of observation information that comprise an access point identifier configured to identify the first access point) and the respective TMEs and/or lateral sides of TMEs that the instances of radio observation information have been assigned to and/or associated with, the first access point is assigned to and/or associated with one or more respective TMEs and/or respective lateral sides of respective TMEs. Based on the one or more respective TMEs and/or respective lateral sides of respective TMEs that the first access point is assigned to and/or associated with and one or more building representations of the digital map, the first access point may be assigned to and/or associated with a building. For example, the first access point may be assigned to and/or associated with a representation of a building in which the first access point is expected to be located.

In various embodiments, a traversable network-aware positioning map may be generated (e.g., created, updated, and/or the like) that may be used to perform radio-based positioning (e.g., determining a position estimate for a computing device based on radio frequency signals and/or access points observed by the computing device). In various embodiments, a traversable network-aware positioning map is a radio-based positioning map that comprises an association and/or an indication thereof between the first access point (and/or at least a portion of a radio model that describes the coverage area and/or transmission parameters of the first access point) and the representation of the building and/or one or more TMEs and/or lateral sides of TMEs. In various embodiments, the traversable network-aware positioning map comprises associations and/or indications thereof between a plurality of access points and respective representations of buildings and/or one or more respective TMEs and/or respective lateral sides of one or more respective TMEs.

Thus, various embodiments provide technical solutions to the technical problems of determining a location of an access point when information regarding the location of the access point is not directly available. In various embodiments, the technical solutions include the generation, provision, and usage of traversable network-aware positioning maps. For example, in various embodiments, traversable network-aware positioning maps may be generated, provided, and/or used that associate access points with one or more respective TMEs and/or a respective lateral side of one or more respective TMEs and/or that associate access points with respective representations of buildings. For example, various embodiments provide the technical advantage of being able to determine along which TMEs and/or one which lateral side of TMEs an access point is located. In another example, various embodiments provide the technical advantage of providing a digital map that may be used for both route determination along portions of a traversable network and radio-based positioning.

In an example embodiment, a processor obtains a plurality of instances of access point observation information. Each instance of access point observation information comprises (a) an instance of radio observation information corresponding to observation of one or more access points by a respective mobile device and (b) an instance of location information comprising an indication of a location of the respective mobile device when the respective mobile device observed the one or more access points. For one or more instances of the plurality of instances of access point observation information, based at least on the instance of location information of the instance of access point observation information and a digital map that is accessible to the at least one processor, the processor identifies a respective traversable map element (TME) of the digital map that represents a portion of a traversable network where the mobile device was located when the mobile device observed the one or more access points; and the processor associates at least a portion of the instance of radio observation information with the respective TME.

In an example embodiment, a processor obtains an instance of radio detection information corresponding to observation of one or more access points by a computing device. The processor, based at least on the instance of radio detection information and positioning map information accessible to the at least one processor, determines a position estimate for the computing device, wherein the positioning map comprises a plurality of instances of access point information, wherein each instance of access point information is associated with at least one of (a) at least one TME of a digital map or (b) a representation of a building.

In one aspect of the present disclosure, a method for associating radio observation information with respective TMEs of a representation of a traversable network provided by a digital map is provided. In an example embodiment, the method comprises obtaining, by at least one processor, a plurality of instances of access point observation information. Each instance of access point observation information comprising (a) an instance of radio observation information corresponding to observation of one or more access points by a respective mobile device and (b) an instance of location information comprising an indication of a location of the respective mobile device when the respective mobile device observed the one or more access points. The method further comprises for one or more instances of the plurality of instances of access point observation information, based at least on the instance of location information of the instance of access point observation information and a digital map that is accessible to the at least one processor, identifying, by the at least one processor, a respective TME of the digital map that represents a portion of a traversable network where the mobile device was located when the mobile device observed the one or more access points; and associating, by the at least one processor, at least a portion of the instance of radio observation information with the respective TME.

In an example embodiment, identifying the respective TME comprises, based at least in on the location information of the instance and the digital map, determining a lateral side of the portion of the traversable network where the mobile device was located when the mobile device observed the one or more access points, wherein associating the at least a portion of the instance of radio observation information with the respective TME comprises associating the at least a portion of the instance of radio observation information with the lateral side of the respective TME. In an example embodiment, the instance of location information comprises a highly-accurate GNSS-based position estimate of the location of the respective mobile devices when the respective mobile device observed the one or more access points. In an example embodiment, the highly-accurate GNSS-based position estimate has sufficient accuracy to unambiguously indicate a road lane on which the mobile device was located when the location information was captured. In an example embodiment, the instance of location information comprises a position estimate and a direction of movement of the respective mobile device when the respective mobile device observed the one or more access points. In various embodiments, the position estimate is a GNSS-based position estimate, an inertial sensor and/or inertial measurement unit (IMU)-based position estimate, a magnetic and/or barometric pressure-sensor based position estimate, and/or a position estimate generated based at least in part on one or more sensors of the mobile device. In an example embodiment, at least one of the respective TME or a lateral side of the respective TME is identified based at least on the direction of movement and a directionality of the respective TME indicated by map data of the digital map. In an example embodiment, the instance of radio observation information comprises, for each access point of the one or more access point (a) an access point identifier configured to identify the access point and (b) a signal strength indicator corresponding to the observed signal strength of the access point.

In an example embodiment, the method further comprises associating a first access point of the one or more access points with at least one TME based at least in part on the signal strength indicator of one or more instances of access point observation information and the respective TME associated with the one or more instances of access point observation information. In an example embodiment, the method further comprises providing an indication of the first access point being associated with the at least one TME such that a computing device receives the indication, the computing device configured to perform a positioning and/or navigation-related function based at least in part on the indication of the first access point being associated with the at least one TME. In an example embodiment, the method further comprises generating a positioning map comprising information corresponding to the first access point associated with the at least one TME. In an example embodiment, the method further comprises, based at least on one or more instances of access point observation information associated with a first access point and respective TMEs associated with the at least a portion of the instance of radio observation information of the one or more instances of access point observation information, determining a building in which the first access point of the one or more access points is located, wherein the digital map comprises a representation of the building; and associating the first access point with the representation of the building. In an example embodiment, the building is selected from two or more buildings located along the respective TME based at least in part on a signal strength indicator associated with the first access point in the one or more instances of access point observation information. In an example embodiment, the method further comprises generating a positioning map comprising information corresponding to the first access point associated with a representation of the building.

According to another aspect of the present disclosure, an apparatus is provided. In an example embodiment, the apparatus comprises at least one processor and at least one memory storing computer program code and/or instructions. The at least one memory and the computer program code and/or instructions are configured to, with the processor, cause the apparatus to at least obtain a plurality of instances of access point observation information. Each instance of access point observation information comprising (a) an instance of radio observation information corresponding to observation of one or more access points by a respective mobile device and (b) an instance of location information comprising an indication of a location of the respective mobile device when the respective mobile device observed the one or more access points. The at least one memory and the computer program code and/or instructions are further configured to, with the processor, cause the apparatus to at least, for one or more instances of the plurality of instances of access point observation information, based at least on the instance of location information of the instance of access point observation information and a digital map that is accessible to the at least one processor, identify a respective TME of the digital map that represents a portion of a traversable network where the mobile device was located when the mobile device observed the one or more access points; and associate at least a portion of the instance of radio observation information with the respective TME.

In an example embodiment, identifying the respective TME comprises, based at least in on the location information of the instance and the digital map, determining a lateral side of the portion of the traversable network where the mobile device was located when the mobile device observed the one or more access points, wherein associating the at least a portion of the instance of radio observation information with the respective TME comprises associating the at least a portion of the instance of radio observation information with the lateral side of the respective TME. In an example embodiment, the instance of location information comprises a highly-accurate GNSS-based position estimate of the location of the respective mobile devices when the respective mobile device observed the one or more access points. In an example embodiment, the highly-accurate GNSS-based position estimate has sufficient accuracy to unambiguously indicate a road lane on which the mobile device was located when the location information was captured. In an example embodiment, the instance of location information comprises a position estimate and a direction of movement of the respective mobile device when the respective mobile device observed the one or more access points. In an example embodiment, at least one of the respective TME or a lateral side of the respective TME is identified based at least on the direction of movement and a directionality of the respective TME indicated by map data of the digital map. In an example embodiment, the instance of radio observation information comprises, for each access point of the one or more access point (a) an access point identifier configured to identify the access point and (b) a signal strength indicator corresponding to the observed signal strength of the access point.

In an example embodiment, the at least one memory and the computer program code and/or instructions are further configured to, with the processor, cause the apparatus to at least associate a first access point of the one or more access points with at least one TME based at least in part on the signal strength indicator of one or more instances of access point observation information and the respective TME associated with the one or more instances of access point observation information. In an example embodiment, at least one memory and the computer program code and/or instructions are further configured to, with the processor, cause the apparatus to at least provide an indication of the first access point being associated with the at least one TME such that a computing device receives the indication, the computing device configured to perform a positioning and/or navigation-related function based at least in part on the indication of the first access point being associated with the at least one TME. In an example embodiment, the at least one memory and the computer program code and/or instructions are further configured to, with the processor, cause the apparatus to at least generate a positioning map comprising information corresponding to the first access point associated with the at least one TME. In an example embodiment, at least one memory and the computer program code and/or instructions are further configured to, with the processor, cause the apparatus to at least, based at least on one or more instances of access point observation information associated with a first access point and respective TMEs associated with the at least a portion of the instance of radio observation information of the one or more instances of access point observation information, determine a building in which the first access point of the one or more access points is located, wherein the digital map comprises a representation of the building; and associate the first access point with the representation of the building. In an example embodiment, the building is selected from two or more buildings located along the respective TME based at least in part on a signal strength indicator associated with the first access point in the one or more instances of access point observation information. In an example embodiment, the at least one memory and the computer program code and/or instructions are further configured to, with the processor, cause the apparatus to at least generate a positioning map comprising information corresponding to the first access point associated with a representation of the building.

In still another aspect of the present disclosure, a computer program product is provided. In an example embodiment, the computer program product comprises at least one non-transitory computer-readable storage medium having computer-readable program code and/or instructions portions stored therein. The computer-readable program code and/or instructions portions comprise executable portions configured, when executed by a processor of an apparatus, to cause the apparatus to obtain a plurality of instances of access point observation information. Each instance of access point observation information comprising (a) an instance of radio observation information corresponding to observation of one or more access points by a respective mobile device and (b) an instance of location information comprising an indication of a location of the respective mobile device when the respective mobile device observed the one or more access points. The computer-readable program code and/or instructions portions comprise executable portions further configured, when executed by a processor of an apparatus, to cause the apparatus to, for one or more instances of the plurality of instances of access point observation information, based at least on the instance of location information of the instance of access point observation information and a digital map that is accessible to the at least one processor, identify a respective TME of the digital map that represents a portion of a traversable network where the mobile device was located when the mobile device observed the one or more access points; and associate at least a portion of the instance of radio observation information with the respective TME.

In an example embodiment, identifying the respective TME comprises, based at least in on the location information of the instance and the digital map, determining a lateral side of the portion of the traversable network where the mobile device was located when the mobile device observed the one or more access points, wherein associating the at least a portion of the instance of radio observation information with the respective TME comprises associating the at least a portion of the instance of radio observation information with the lateral side of the respective TME. In an example embodiment, the instance of location information comprises a highly-accurate GNSS-based position estimate of the location of the respective mobile devices when the respective mobile device observed the one or more access points. In an example embodiment, the highly-accurate GNSS-based position estimate has sufficient accuracy to unambiguously indicate a road lane on which the mobile device was located when the location information was captured. In an example embodiment, the instance of location information comprises a position estimate and a direction of movement of the respective mobile device when the respective mobile device observed the one or more access points. In an example embodiment, at least one of the respective TME or a lateral side of the respective TME is identified based at least on the direction of movement and a directionality of the respective TME indicated by map data of the digital map. In an example embodiment, the instance of radio observation information comprises, for each access point of the one or more access point (a) an access point identifier configured to identify the access point and (b) a signal strength indicator corresponding to the observed signal strength of the access point.

In an example embodiment, the computer-readable program code and/or instructions portions comprise executable portions further configured, when executed by a processor of an apparatus, to cause the apparatus to associate a first access point of the one or more access points with at least one TME based at least in part on the signal strength indicator of one or more instances of access point observation information and the respective TME associated with the one or more instances of access point observation information. In an example embodiment, computer-readable program code and/or instructions portions comprise executable portions further configured, when executed by a processor of an apparatus, to cause the apparatus to provide an indication of the first access point being associated with the at least one TME such that a computing device receives the indication, the computing device configured to perform a positioning and/or navigation-related function based at least in part on the indication of the first access point being associated with the at least one TME. In an example embodiment, the computer-readable program code and/or instructions portions comprise executable portions further configured, when executed by a processor of an apparatus, to cause the apparatus to generate a positioning map comprising information corresponding to the first access point associated with the at least one TME. In an example embodiment, computer-readable program code and/or instructions portions comprise executable portions further configured, when executed by a processor of an apparatus, to cause the apparatus to, based at least on one or more instances of access point observation information associated with a first access point and respective TMEs associated with the at least a portion of the instance of radio observation information of the one or more instances of access point observation information, determine a building in which the first access point of the one or more access points is located, wherein the digital map comprises a representation of the building; and associate the first access point with the representation of the building. In an example embodiment, the building is selected from two or more buildings located along the respective TME based at least in part on a signal strength indicator associated with the first access point in the one or more instances of access point observation information. In an example embodiment, the computer-readable program code and/or instructions portions comprise executable portions further configured, when executed by a processor of an apparatus, to cause the apparatus to generate a positioning map comprising information corresponding to the first access point associated with a representation of the building.

According to yet another aspect, an apparatus is provided. In an example embodiment, the apparatus comprises means for obtaining a plurality of instances of access point observation information. Each instance of access point observation information comprising (a) an instance of radio observation information corresponding to observation of one or more access points by a respective mobile device and (b) an instance of location information comprising an indication of a location of the respective mobile device when the respective mobile device observed the one or more access points. The apparatus comprises means for, for one or more instances of the plurality of instances of access point observation information, based at least on the instance of location information of the instance of access point observation information and a digital map that is accessible to the at least one processor, identifying, by the at least one processor, a respective TME of the digital map that represents a portion of a traversable network where the mobile device was located when the mobile device observed the one or more access points; and associating, by the at least one processor, at least a portion of the instance of radio observation information with the respective TME.

According to another aspect of the present disclosure, a method for using a traversable network-aware positioning map. In an example embodiment, the method comprises obtaining, by at least one processor, an instance of radio detection information corresponding to observation of one or more access points by a computing device. The method further comprises, based at least on the instance of radio detection information and positioning map information accessible to the at least one processor, determining, by the at least one processor, a position estimate for the computing device. The positioning map comprises a plurality of instances of access point information, wherein each instance of access point information is associated with at least one TME of a digital map.

In an example embodiment, the method further comprises performing at least one positioning and/or navigation-related function based at least in part on the position estimate and the digital map. In an example embodiment, at least one instance of access point information is associated with a representation of a building in the digital map. In an example embodiment, at least one instance of access point information is associated with a lateral side of the at least one TME.

According to another aspect of the present disclosure, an apparatus is provided. In an example embodiment, the apparatus comprises at least one processor and at least one memory storing computer program code and/or instructions. The at least one memory and the computer program code and/or instructions are configured to, with the processor, cause the apparatus to at least obtain an instance of radio detection information corresponding to observation of one or more access points by a computing device; and, based at least on the instance of radio detection information and positioning map information accessible to the at least one processor, determine a position estimate for the computing device. The positioning map comprises a plurality of instances of access point information, wherein each instance of access point information is associated with at least one TME of a digital map.

In an example embodiment, the at least one memory and the computer program code and/or instructions are further configured to, with the processor, cause the apparatus to at least perform at least one positioning and/or navigation-related function based at least in part on the position estimate and the digital map. In an example embodiment, at least one instance of access point information is associated with a representation of a building in the digital map. In an example embodiment, at least one instance of access point information is associated with a lateral side of the at least one TME.

In still another aspect of the present disclosure, a computer program product is provided. In an example embodiment, the computer program product comprises at least one non-transitory computer-readable storage medium having computer-readable program code and/or instructions portions stored therein. The computer-readable program code and/or instructions portions comprise executable portions are configured, when executed by a processor of an apparatus, to cause the apparatus to obtain an instance of radio detection information corresponding to observation of one or more access points by a computing device; and, based at least on the instance of radio detection information and positioning map information accessible to the at least one processor, determine a position estimate for the computing device. The positioning map comprises a plurality of instances of access point information, wherein each instance of access point information is associated with at least one TME of a digital map.

In an example embodiment, the computer-readable program code and/or instructions portions comprise executable portions are further configured, when executed by a processor of an apparatus, to cause the apparatus to perform at least one positioning and/or navigation-related function based at least in part on the position estimate and the digital map. In an example embodiment, at least one instance of access point information is associated with a representation of a building in the digital map. In an example embodiment, at least one instance of access point information is associated with a lateral side of the at least one TME.

According to yet another aspect, an apparatus is provided. For example, the apparatus comprises means for obtaining an instance of radio detection information corresponding to observation of one or more access points by a computing device. The apparatus comprises means for, based at least on the instance of radio detection information and positioning map information accessible to the at least one processor, determining a position estimate for the computing device. The positioning map comprises a plurality of instances of access point information, wherein each instance of access point information is associated with at least one TME of a digital map.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example system of one embodiment of the present disclosure;

FIG. 2A is a block diagram of a network device that may be specifically configured in accordance with an example embodiment;

FIG. 2B is a block diagram of a mobile device that may be specifically configured in accordance with an example embodiment;

FIG. 2C is a block diagram of a computing device that may be specifically configured in accordance with an example embodiment;

FIG. 3 is a conceptual diagram illustrating various features of various embodiments;

FIG. 4 is a flowchart illustrating operations performed, such as by the mobile device of FIG. 2B, in accordance with an example embodiment;

FIG. 5 is a flowchart illustrating operations performed, such as by the network device of FIG. 2A or the mobile device of FIG. 2B, in accordance with an example embodiment;

FIG. 6 is a conceptual diagram showing a slightly zoomed out version of the portion of the roadway illustrated in FIG. 3;

FIG. 7 is a flowchart illustrating operations performed, such as by the computing device of FIG. 2C, in accordance with an example embodiment; and

FIG. 8 is a flowchart illustrating operations performed, such as by the network device of FIG. 2A or the computing device of FIG. 2C, in accordance with an example embodiment.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. As used herein, the terms “substantially” and “approximately” refer to values and/or tolerances that are within manufacturing and/or engineering guidelines and/or limits. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

### I. General Overview

Various embodiments provide methods, apparatus, systems, and computer program products for associating radio observation information with a TME of a digital map configured to represent a traversable network. Various embodiments provide methods, apparatus, systems, and computer program products for generating, providing and/or using a traversable network-aware positioning map and/or portions thereof that include an association and/or indication of an association between one or more access points and one or more respective TMEs, respective lateral sides of one or more respective TMEs, and/or respective representations of buildings.

In various embodiments, instances of radio observation information corresponding to a first access point is assigned to and/or associated with one or more respective TMEs of a digital map. In an example embodiment, an instance of radio observation information corresponding to the first access point is assigned to and/or associated with a TME of the digital map where a mobile device was located when the mobile device observed the first access point. Based on instances of radio observation information corresponding to the first access point and the respective TMEs that the instances of radio observation information are assigned to and/or associated with, the first access point is assigned to and/or associated with one or more respective TMEs and/or respective lateral sides of one or more respective TMEs. In various embodiments, a traversable network-aware positioning map is generated (e.g., created, updated, and/or the like) that comprises an indication of the first access point being assigned to and/or associated with one or more TMEs of the digital map and/or with a representation of a building of the digital map. For example, the digital map may comprise two-dimensional or three-dimensional representations of buildings associated with TMEs that respectively represent buildings located along the corresponding traversable elements of the traversable network. For example, the traversable network-aware positioning map is a layer of the digital map and/or a component (e.g., sub-database) of a geographic database, in an example embodiment. The traversable network-aware positioning map may then be used to determine positioning estimates of and/or perform one or more positioning and/or navigation-related functions for computing devices based on access points observed by the computing devices.

For example, one or more mobile devices may be onboard a vehicle and/or otherwise traversing at least a portion of a traversable network (e.g., onboard a passenger car traversing at least a portion of a road network). For example, the mobile device may be a smartphone and/or tablet (or other mobile computing device), an navigation system, a vehicle control system (e.g., an advanced driver assistance system (ADAS), automated vehicle control system, and/or the like). As a mobile device traverses at least a portion of the traversable network, the mobile device captures and provides one or more instances of access point observation information. In an example embodiment, an instance of access point observation information includes an instance of radio observation information and a corresponding instance of location information. The instance of radio observation information corresponds to the observation of one or more access points by the mobile device. In various embodiments, an instance of radio observation information comprises a respective access point identifier for each of one or more access points observed by the mobile device. In various embodiments, a mobile device observes an access point by receiving, detecting, capturing, measuring, and/or the like a signal (e.g., a radio frequency signal) generated by the access point. For example, a mobile device may determine an access point identifier, a received signal strength, a one-way or round trip time for communicating with the access point, a channel or frequency of the access point, and/or the like based on the mobile device's observation of the access point.

In various embodiments, an instance of radio observation information further includes one or more measurements characterizing the observation of an access point by the mobile device. For example, when the mobile device observes a first access point, the instance of radio observation information comprises an access point identifier configured to identify the first access point and one or more measurement values such as the signal strength of the observed radio frequency signal generated, broadcasted, transmitted, and/or the like by the first access point; a one way or round trip time value for communication (one way or two way communication) between the first access point and the mobile device; a channel and/or frequency of transmission used by the first access point; and/or the like characterizing the observation of the first access point by the mobile device.

In various embodiments, an instance of access point observation information further comprises a corresponding instance of location information. In various embodiments, the corresponding instance of location information provides an indication of the location of the mobile device when the mobile device observed the first access point. For example, in various embodiments, the location information comprises, a GNSS-based position estimate or other position estimate of the mobile device when the radio observation information was captured. In various embodiments, the position estimate is a GNSS-based position estimate, an inertial sensor and/or inertial measurement unit (IMU)-based position estimate, a magnetic and/or barometric pressure-sensor based position estimate, and/or a position estimate generated based at least in part on one or more sensors of the mobile device. For example, the location information may comprise a highly-accurate GNSS-based position estimate and/or a GNSS-based position estimate (or other position estimate) and a direction of travel of the mobile device. Based on the location information, a TME and/or a lateral side of a TME of a digital map that the mobile device was located at and/or traversing when the mobile device observed the access point is determined. In various embodiments, a TME is a representation of at least a portion of a road and/or path segment, such as a road and/or path (e.g., bike or pedestrian path) segment, a lane of a road and/or path, a set of lanes of a road and/or path segment having a common direction of travel (e.g., all of the lanes corresponding to the TME are configured to be traveled in the same direction), and/or the like. In various embodiments, a road and/or path segment is the segment of a road and/or path (e.g., bike and/or pedestrian path) defined by and/or disposed between two sequential intersections. For example a segment of a road and/or path does not include any intersections along its length but does start at an intersection and end at another intersection. In an example embodiment, an instance of location information comprises a timestamp indicating a date and/or time at which the mobile device observed the first access point.

An instance of radio observation information is assigned to and/or associated with a TME and/or a lateral side of a TME based on the TME and/or lateral side of the TME determined for the corresponding instance of location information (e.g., the instance of location information included in the same instance of access point observation information as the instance of radio observation information). Based on a plurality of instances of observation information corresponding to a first access point (e.g., a plurality of instances of observation information that comprise an access point identifier configured to identify the first access point) and the respective TMEs and/or lateral sides of TMEs that the instances of radio observation information have been assigned to and/or associated with, the first access point is assigned to and/or associated with one or more respective TMEs and/or respective lateral sides of respective TMEs. Based on the one or more respective TMEs and/or respective lateral sides of respective TMEs that the first access point is assigned to and/or associated with and one or more building representations of the digital map, the first access point may be assigned to and/or associated with a building. For example, the first access point may be assigned to and/or associated with a representation of a building in which the first access point is expected to be located.

In various embodiments, a traversable network-aware positioning map may be generated (e.g., created, updated, and/or the like) that may be used to perform radio-based positioning (e.g., determining a position estimate for a computing device based on radio frequency signals and/or access points observed by the computing device). In various embodiments, the traversable network-aware positioning map comprises an association and/or an indication thereof between the first access point and the representation of the building and/or one or more TMEs and/or lateral sides of TMEs. In various embodiments, the traversable network-aware positioning map comprises associations and/or indications thereof between a plurality of access points and respective representations of buildings and/or one or more respective TMEs and/or respective lateral sides of one or more respective TMEs.

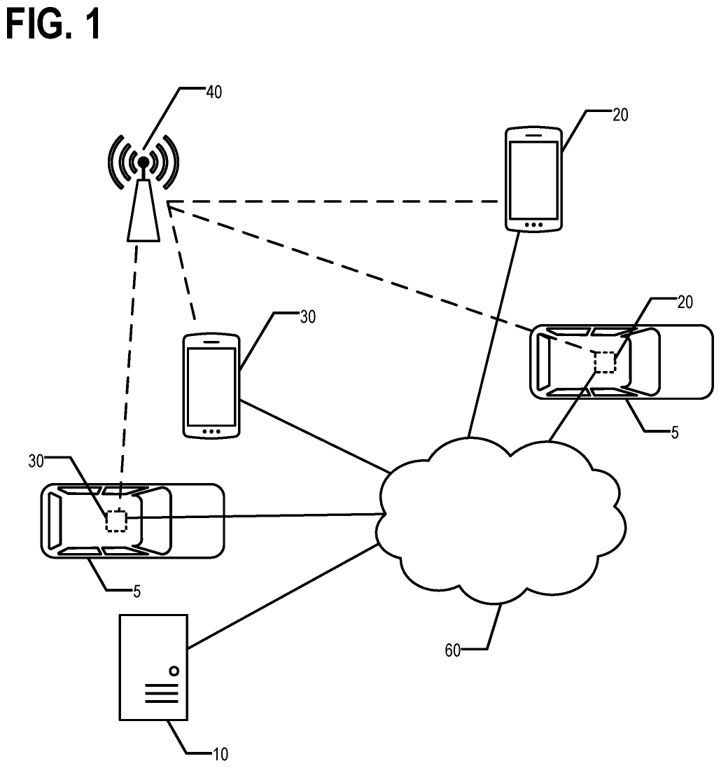

FIG. 1 provides an illustration of an example system that can be used in conjunction with various embodiments of the present invention. As shown in FIG. 1, the system includes one or more network devices 10, one or more mobile devices 20, one or more computing devices 30, one or more networks 60, and/or the like. In an example embodiment, the network device 10 is a server, group of servers, distributed computing system, part of a cloud-based computing system, and/or other computing system. In various embodiments, mobile devices 20 and/or computing devices 30 may be onboard a respective vehicle 5. For example, in various embodiments, the mobile device 20 and/or computing device 30 is an in vehicle navigation system, vehicle control system, a mobile computing device, a mobile data gathering platform, and/or the like. For example, a mobile device 20 and/or computing device 30 may be an in vehicle navigation system mounted within and/or be onboard a vehicle 5 such as a motor vehicle, non-motor vehicle, automobile, car, scooter, truck, van, bus, motorcycle, bicycle, Segway, golf cart, and/or the like. In an example embodiment, the mobile device 20 and/or computing device 30 is a vehicle control system configured to autonomously drive a vehicle 5, assist in control of a vehicle 5, monitor various aspects of the vehicle 5 (e.g., fault conditions, motor oil status, battery charge level, fuel tank fill level, and/or the like) and/or the like. In various embodiments, the mobile device 20 and/or computing device 30 is configured to autonomously drive a vehicle 5 and may perform multiple functions that are similar to those performed by a mobile device 20 and/or computing device 30 configured to be an ADAS (e.g., lane keeping, lane change assistance, maintaining a lane, merging, etc.). In some embodiments, a mobile device 20 and/or computing device 30 is onboard a personal vehicle, commercial vehicle, public transportation vehicle, fleet vehicle, and/or other vehicle. In various embodiments, a mobile device 20 and/or a computing device 30 is a smart phone, tablet, laptop, personal digital assistant (PDA), mobile computing device, navigation system, vehicle control system (e.g., ADAS or automated vehicle control system), and/or the like. In an example embodiment, a mobile device 20 and/or computing device 30 is onboard a vehicle 5 and is used to perform one or more positioning and/or navigation-related functions corresponding to the vehicle 5 traversing at least a portion of a traversable network (e.g., a road network).

In various embodiments, the system further includes one or more access points 40. In various embodiments, the access points 40 are wireless network access points and/or gateways such as Wi-Fi network access points, cellular network access points, Bluetooth access points, and/or other radio frequency-based network access points. In various embodiments, the network device 10 communicates with one or more mobile devices 20 and/or computing devices 30 via one or more wired or wireless networks 60. In various embodiments, an access point 40 is a wireless access point that may be used by a mobile device 20 and/or computing device 30 may use to communicate with network 60. In various embodiments, an access point 40 need not be an access point for accessing network 60.

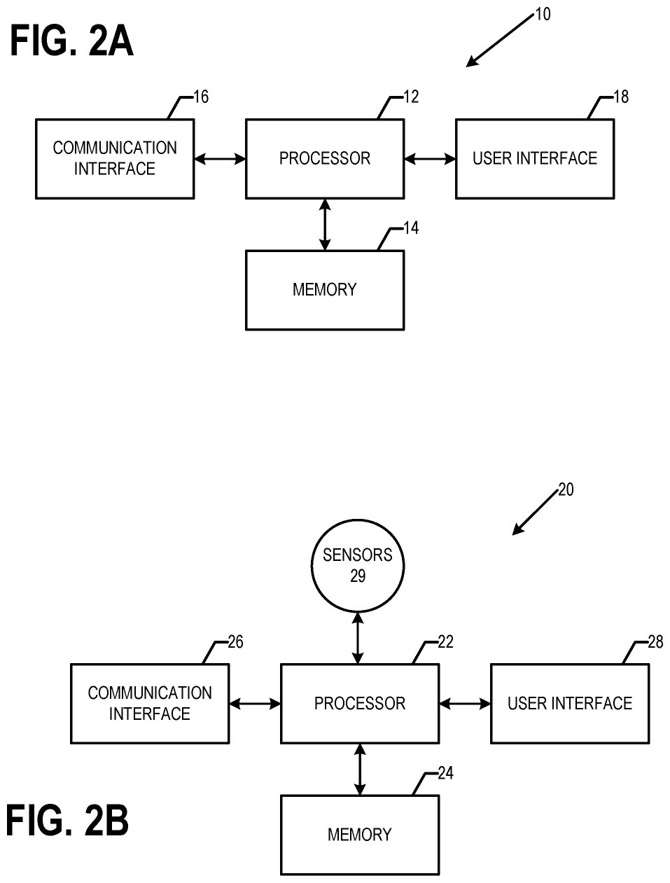

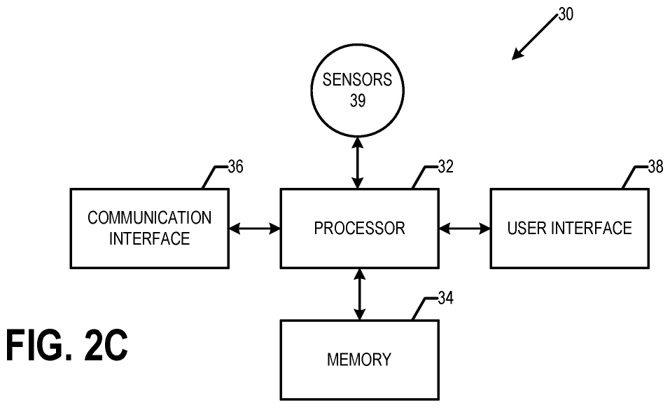

In an example embodiment, a network device 10 may comprise components similar to those shown in the example network device 10 diagrammed in FIG. 2A. In an example embodiment, the network device 10 is configured to obtain a plurality of instances of access point observation information; assign and/or associate instances of radio observation information with respective TMEs and/or respective lateral sides of respective TMEs; assign and/or associate access points to respective TMEs, respective lateral sides of respective TMEs, and/or respective representations of buildings; generate traversable network-aware positioning maps including indications of access points being assigned to and/or associated with respective TMEs, respective lateral sides of respective TMEs, and/or respective representations of buildings; provide and/or use the traversable network-aware positioning maps to perform positioning and/or navigation-related functions; and/or the like.

For example, as shown in FIG. 2A, the network device 10 may comprise a processor 12, memory 14, a user interface 18, a communications interface 16, and/or other components configured to perform various operations, procedures, functions, or the like described herein. In various embodiments, the network device 10 stores a geographical database, digital map, and/or positioning map, such as a radio environment and/or cellular network access point positioning map (e.g., an access point registry), computer program code and/or instructions for performing various functions described herein, and/or the like (e.g., in memory 14), for example. In at least some example embodiments, the memory 14 is non-transitory.

In an example embodiment, the mobile device 20 is configured to capture instances of access point observation information, provide the instances of access point observation information, and/or the like.

In an example embodiment, the mobile device 20 is a mobile computing device such as a smartphone, tablet, laptop, PDA, navigation system, vehicle control system, an Internet of things (IoT) device, and/or the like. In an example embodiment, as shown in FIG. 2B, the mobile device 20 may comprise a processor 22, memory 24, a communications interface 26, a user interface 28, one or more sensors 29 and/or other components configured to perform various operations, procedures, functions or the like described herein. In various embodiments, the mobile device 20 stores at least a portion of one or more digital maps (e.g., geographic databases, positioning maps, and/or the like) and/or computer executable instructions for generating and/or providing instances of access point observation information, and/or the like in memory 24. In at least some example embodiments, the memory 24 is non-transitory.

In various embodiments, the sensors 29 comprise one or more IMU sensors, one or more GNSS sensors, one or more radio sensors, and/or other sensors. In an example embodiment, the one or more IMU sensors comprise one or more accelerometers, gyroscopes, magnetometers, and/or the like. In various embodiments, the one or more GNSS sensor(s) are configured to communicate with one or more GNSS satellites and determine GNSS-based position estimates and/or other information based on the communication with the GNSS satellites. In various embodiments, the one or more radio sensors comprise one or more radio interfaces configured to observe and/or receive signals generated and/or transmitted by one or more access points and/or other computing entities (e.g., access points 40). For example, the one or more interfaces may be configured (possibly in coordination with processor 22) to determine a locally unique identifier, globally unique identifier, and/or operational parameters of a network access point 40 observed by the radio sensor(s). As used herein, a radio sensor observes an access point 40 by receiving, capturing, measuring and/or observing a signal generated and/or transmitted by the access point 40. In an example embodiment, the interface of a radio sensor may be configured to observe one or more types of signals such as generated and/or transmitted in accordance with one or more protocols such as 5G, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface of a radio sensor may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface(s) of the radio senor(s) may be configured to observe radio, millimeter, microwave, and/or infrared wavelength signals. In an example embodiment, the interface of radio sensor may be coupled to and/or part of a communications interface 26. In various embodiments, the sensors 29 may further comprise one or more image sensors configured to capture visual samples, such as digital camera(s), 3D cameras, 360° cameras, and/or image sensors. In various embodiments, the one or more sensors 29 may comprise various other sensors such as two dimensional (2D) and/or three dimensional (3D) light detection and ranging (LiDAR)(s), long, medium, and/or short range radio detection and ranging (RADAR), ultrasonic sensors, electromagnetic sensors, (near-) infrared (IR) cameras.

In an example embodiment, the computing device 30 is configured to capture instances of radio observation information, generate and/or receive a positioning estimate generated and/or determined using a traversable network-aware positioning map, and/or the like.

In an example embodiment, the computing device 30 is a mobile computing device such as a smartphone, tablet, laptop, PDA, navigation system, vehicle control system, an Internet of things (IoT) device, and/or the like. In an example embodiment, as shown in FIG. 2C, the computing device 30 may comprise a processor 32, memory 34, a communications interface 36, a user interface 38, one or more sensors 39 and/or other components configured to perform various operations, procedures, functions or the like described herein. In various embodiments, the computing device 30 stores at least a portion of one or more digital maps (e.g., geographic databases, positioning maps, and/or the like) and/or computer executable instructions for generating and/or providing instances of radio observation information, and/or the like in memory 34. In at least some example embodiments, the memory 34 is non-transitory.

In various embodiments, the sensors 39 comprise one or more IMU sensors, one or more GNSS sensors, one or more radio sensors, and/or other sensors. In an example embodiment, the one or more IMU sensors comprise one or more accelerometers, gyroscopes, magnetometers, and/or the like. In various embodiments, the one or more GNSS sensor(s) are configured to communicate with one or more GNSS satellites and determine GNSS-based position estimates and/or other information based on the communication with the GNSS satellites. In various embodiments, the one or more radio sensors comprise one or more radio interfaces configured to observe and/or receive signals generated and/or transmitted by one or more access points and/or other computing entities (e.g., access points 40). For example, the one or more interfaces may be configured (possibly in coordination with processor 32) to determine a locally unique identifier, globally unique identifier, and/or operational parameters of a network access point 40 observed by the radio sensor(s). As used herein, a radio sensor observes an access point 40 by receiving, capturing, measuring and/or observing a signal generated and/or transmitted by the access point 40. In an example embodiment, the interface of a radio sensor may be configured to observe one or more types of signals such as generated and/or transmitted in accordance with one or more protocols such as 5G, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface of a radio sensor may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface(s) of the radio senor(s) may be configured to observe radio, millimeter, microwave, and/or infrared wavelength signals. In an example embodiment, the interface of radio sensor may be coupled to and/or part of a communications interface 36. In various embodiments, the sensors 39 may further comprise one or more image sensors configured to capture visual samples, such as digital camera(s), 3D cameras, 360° cameras, and/or image sensors. In various embodiments, the one or more sensors 39 may comprise various other sensors such as two dimensional (2D) and/or three dimensional (3D) light detection and ranging (LiDAR)(s), long, medium, and/or short range radio detection and ranging (RADAR), ultrasonic sensors, electromagnetic sensors, (near-) infrared (IR) cameras.

Each of the components of the system may be in electronic communication with, for example, one another over the same or different wireless or wired networks 60 including, for example, a wired or wireless Personal Area Network (PAN), Local Area Network (LAN), Metropolitan Area Network (MAN), Wide Area Network (WAN), cellular network, and/or the like. In an example embodiment, a network 60 comprises the automotive cloud, digital transportation infrastructure (DTI), radio data system (RDS)/high definition (HD) radio or other digital radio system, and/or the like. For example, a mobile device 20 and/or a computing device 30 may be in communication with a network device 10 via the network 60. For example, a mobile device 20 and/or computing device 30 may communicate with the network device 10 via a network, such as the Cloud. For example, the Cloud may be a computer network that provides shared computer processing resources and data to computers and other devices connected thereto. For example, the mobile device 20 captures an instance of access point observation information and provides the instances of access point observation information such that the network device 10 receives the instances of access point observation via the network 60. For example, the computing device 30 captures instances of radio observation information and provides the instances of radio observation information such that the network device 10 receives the instances of radio observation information. For example, the computing device 30 receives positioning estimates and/or at least a portion of a traversable network-aware positioning map via the network 60. For example, the network device 10 may be configured to receive instances of access point observation information and/or instances of radio observation information and/or provide positioning estimates and/or at least portions of a traversable network-aware positioning map via the network 60.

Certain example embodiments of the network device 10, mobile device 20, and computing device 30 are described in more detail below with respect to FIGS. 2A, 2B, and 2C.

### II. Example Operation(s)

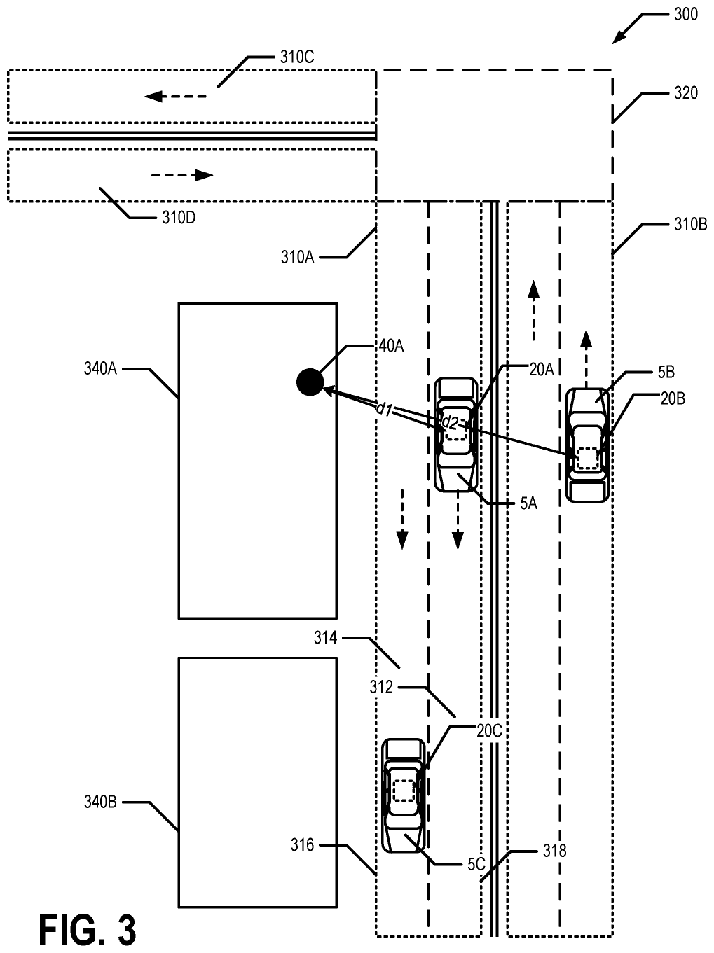

FIG. 3 provides a conceptual diagram illustrating various concepts relating to various embodiments. FIG. 3 illustrates a portion of a digital map that provides a representation 300 of a portion of a road network. As should be understood, the portion of the road network is an example of a portion of a traversable network. The representation 300 of the portion of the road network comprises first TME 310A, second TME 310B, third TME 310C, and third TME 310D. Each of the TMEs 310A-D correspond to a road segment, travel lane of a road segment, and/or set of (adjacent) travel lanes having a common direction of travel of a road segment. One end of each of the first, second, third, and fourth TMEs 310A-D is defined by intersection 320. In the illustrated scenario, the first TME 310A comprises a left lane 312 and a right lane 314. The outer edge of the left lane 312 defines a left lateral side 318 of the first TME 310A and the outer edge of the right lane 314 define a right lateral side 316 of the first TME 310A. Here, right and left refer to right and left, respectively of a vehicle traversing the corresponding TME in the direction of travel of the TME.

The representation 300 of the portion of the road network further comprises a representation of a first building 340A and a representation of a second building 340B. In an example embodiment, the representation of the first building 340A and/or the second building 340B is a two-dimensional representation, such as a building footprint. In an example embodiment, the representation of the first building 340A and/or the second building 340B is a three dimensional representation such as a three-dimensional model, a multi-floored map of the building, and/or the like. A first access point 40A is located within the first building 340A. In an example embodiment, a representation of a building is associated with a mailing address, a georeferenced location (e.g., a latitude and longitude pair), a display point indicating where the representation of the building should be displayed on a display of a representation of a portion of the traversable network, a route-to point indicating a point to where a route having the building as a destination should guide a user, and/or the like.

A first vehicle 5A, having a first mobile device 20A onboard, traverses the first TME 310A. As the first vehicle 5A traverses the first TME 310A, the first mobile device 20A observes the first access point 40A. For example, the first mobile device 20A captures, measures, detects, and/or the like a signal generated, broadcasted, transmitted, and/or the like by the first access point 40A. The first mobile device 20A generates a first instance of radio observation information configured to characterize the observation of the first access point 40A by the first mobile device 20A. For example, in an example embodiment, the first instance of radio observation information comprises an access point identifier configured to identify the first access point, a signal strength indicator corresponding to the observed signal strength of the first access point, a time parameter corresponding to the observed one-way or round trip time for communicating with the first access point 40A, and/or the like.

The first mobile device 20A also determines a location of the first mobile device 20A and/or the first vehicle 5A when the first mobile device 20A observed the first access point 40A. For example, a GNSS sensor 29 of the first mobile device 20A may be used to determine a location of the first mobile device 20A when the first mobile device 20A observed the first access point 20A. The first mobile device 20A generates first location information indicating the location of the first mobile device 20A when the first mobile device 20A. In various embodiments, the first instance of location information comprises a highly-accurate GNSS-based position estimate of the first mobile device 20A and/or a position estimate and a direction of movement of the first mobile device 20A when the first mobile device 20A observed the first access points. In various embodiments, the position estimate and direction of movement of the first mobile device 20A is determined at least in part using one or more of GNSS-based positioning techniques, radio-based positioning techniques, IMU-based positioning techniques, visual odometry-based positioning techniques, and/or the like, and/or a combination thereof. In various embodiments, a highly-accurate GNSS-based position estimate is a position estimate that has sufficient accuracy to unambiguously indicate a road lane on which the first mobile device was located when the first mobile device observed the first access point.

In various embodiments, the first mobile device 20A may then bundle, combine, compress, format, and/or the like the first instance of radio observation information and the first instance of location information into a first instance of access point observation information and provides the first instance of access point observation information. For example, the first mobile device 20A may transmit (e.g., via network 60) the first instance of access point observation information such that a network device 10 receives the first instance of access point observation information.

Similarly, a second mobile device 20B traversing the second TME 310B observes the first access point 40A. The second mobile device 20B generates a second instance of radio observation information characterizing the observation of the first access point 40A by the second mobile device 20B and a second instance of location information indicating a location of the second mobile device 20B when the second mobile device observed the first access point. The second mobile device 20B then bundles, combines, compresses, formats, and/or the like the second instance of radio observation information and the second instance of location information into a second instance of access point observation information and provides the second instance of access point observation information. For example, the second mobile device 20B may transmit (e.g., via network 60) the second instance of access point observation information such that a network device 10 receives the second instance of access point observation information.

The network device 10 receives the first and second instances of access point observation information. Based on the first instance of location information, the network device 10 determines that the first mobile device 20A was traversing the first TME 310A when the first mobile device 20A observed the first access point 40A. For example, the network device 10 may map match a first location indicated by the first instance of location information to the first TME 310A based on the position estimate. In an example embodiment, the position estimate is a highly-accurate GNSS-based position estimate such that the travel lane that the first mobile device 20A was traversing when the first mobile device 20A observed the first access point 40A (e.g., the instance of observation of the first mobile device 40A that is corresponds to and/or is recorded by first instance of radio observation information) can be unambiguously determined based on the position estimate alone (e.g., based only on the position estimate and map data of the digital map). In an example embodiment, for example an embodiment in which the position estimate is not a highly-accurate GNSS-based position estimate, the map matching is performed using the position estimate and the direction of travel of the mobile device 20 (and map data of the digital map). The network device 10 may therefore assign and/or associate the first instance of radio observation information with the first TME 310A. Based on the second instance of location information, the network device 10 determines that the second mobile device 20B was traversing the second TME 310B when the second mobile device 20B observed the first access point 40A. The network device 10 may therefore assign and/or associate the first instance of radio observation information with the second TME 310B.

In various embodiments, the network device 10 process the first and second instances of radio observation data and determines that the first instance of radio observation data comprises a signal strength indicator indicating a greater signal strength of the first access point 40A and/or a time parameter indicating a shorter one-way or round trip communication time for communicating with the first access point 40A compared to corresponding parameters of the second instance of radio observation data. For example, comparison of the signal strength indicators and/or time parameters of the first and second instances of radio observation information may indicate that the first instance of radio observation information was captured at a location closer to the location of the first access point 40A compared to the location where the second instance of radio observation information was captured. For example, the distance between the location where the first instance of radio observation information was captured and the location of the first access point 40A is d1 and distance between the location where the second instance of radio observation information was captured and the location of the first access point 40A is d2, with d1 being less than d2. The network device 10 may therefore assign and/or associate the first access point 40A with the first TME 310A. In an example embodiment, since the first and second TMEs 310A, 310B are parallel TMEs, based on the described signal strength and/or time parameter comparison, the network device 10 may assign and/or associate the first access point 40A with the right side of the first TME 310A. In an example embodiment, an access point is associated with cardinal direction or other directional indicator configured to identify a lateral edge or side of a TME. For example, when the second TME 310B has a travel direction of north, the first access point 40A may be associated with a western lateral side of the second TME 310B.

Similarly, mobile devices 20 traversing the third and/or fourth TMEs 310C, 310D may generate and provide instances of access point observation information corresponding to observations of at least the first access point 40A. The network device 10 may receive the instances of access point observation information generated and provided by the mobile devices 20 traversing the third and/or fourth TMEs 310C, 310D. Each instance of radio observation of the instances of access point observation information generated and provided by the mobile devices 20 traversing the third and/or fourth TMEs 310C, 310D is assigned to and/or associated with the TME 310 that the corresponding mobile device 20 was traversing when the instance of access point observation information was generated (e.g., based on the respective instance of location information). The first access point 40A is then assigned to and/or associated with the fourth TME 310D, the right side of the fourth TME 310D, the southern lateral side of the third or fourth TMEs 310C, 310D (in the example where the second TME 310B has a travel direction of north), and/or the like.

In an example embodiment, the first access point 40A is assigned to and/or associated with the representation of the first building 340A based on the assignment and/or association of the first access point 40A with one or more TMEs, lateral sides of TMEs, lateral sides of road segments, and/or the like. In an example embodiment, the first access point 40A is assigned to and/or associated with the representation of the first building 340A rather the representation of the second building 340B based on a comparison of various instances of radio observation information indicating that the signal strength indicators indicate greater observed signal strength and/or the time parameters indicate a shorter one-way or round trip communication time for instances of radio observations corresponding to instance of location information indicating a location closer to the first building. For example, a third instance of radio observation information captured and/or generated by a third mobile device 20C onboard a third vehicle 5C may comprise a signal strength indicator indicating a lower observed signal strength than a signal strength indicator of the first or second instances of radio observation information. For example, the third instance of radio observation information may comprise a time parameter indicating a longer one-way or round trip communication time with the first access point 40A compared to the first or second instances of radio observation information. Therefore, based on the corresponding first, second, and third instances of location information, the network device 10 may determine that instances of radio observation information captured closer to the first building 340A indicate a greater observed signal strength and shorter one-way or round trip communication time for the first access point 40A than instances of radio observation information captured closer to the second building 340B.

Based on the instances of radio observation information assigned and/or associated to respective TMEs, lateral sides of TMEs, and/or lateral sides of road segments; the assignment and/or association of access points identified by the instances of radio observation information to respective TMEs, lateral sides of TMEs, lateral sides of road segments, and/or representations of buildings; and/or map data of a digital map (e.g., geographic database) a traversable network-aware positioning map may be generated, (e.g., created, updated, and/or the like). In various embodiments, a traversable network-aware positioning map comprises information regarding one or more access points 40 associated with respective TMEs, locations within a traversable network, a representation of a building, and/or the like. For example, a traversable network-aware positioning map is a digital map comprising both TME data records and access point data records, in an example embodiment. For example, a traversable network-aware positioning map is a digital map comprising a traversable network layer and an access point layer, in an example embodiment. The traversable network layer comprises information/data regarding TMEs, road and/or path segments, intersections, and/or the like that provide a representation of at least a portion of the traversable network. The access point layer comprises radio positioning information/data that identifies access points 40 and their respective locations, comprises radio models corresponding to and/or representing the coverage and/or broadcast area of one or more access points 40, provides a description of the radio environment (e.g., collection of radio frequency signals) observed and/or observable at various locations, and/or the like such that the radio positioning information/data is associated with TMEs, lateral sides of TMEs, lateral sides of road and/or path segments, and/or the like of the traversable network layer.

Once generated, the traversable network-aware positioning map may be used to perform one or more positioning and/or navigation-related functions for one or more computing devices 30 (e.g., performed by a network device 10 and/or a computing device 30). Some non-limiting examples of positioning and/or navigation-related functions include providing a route or information corresponding to a geographic area (e.g., via a user interface), localization, localization visualization, route determination, lane level route determination, operating a vehicle along at least a portion of a route, operating a vehicle along at least a portion of a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, and/or the like.

### Exemplary Operation of a Mobile Device

In various embodiments, one or more mobile devices 20 traverse at least respective portions of one or more traversable networks. One or more of the mobile devices 20 may be onboard vehicles. As the mobile devices 20 traverse their at least respective portions of one or more traversable networks, the mobile devices 20 observe various access points 40 and generate corresponding instances of radio observation information. In an example embodiment, an instance of radio observation information corresponds to and/or comprises information regarding the observation of only one access point 40. In an example embodiment, an instance of radio observation information corresponds to and/or comprises information regarding the observation of one or more access points 40 observed at a single location (e.g., each of the one or more access points 40 were observed while the mobile device 20 was located at the same position). The mobile devices 20 determine respective location indicating a location of the respective mobile device 20 when the one or more access points 40 were observed. For example, radio sensors and location sensors (e.g., sensors used for GNSS-based positioning, radio-based positioning, IMU-based positioning, visual odometry, and/or various combinations thereof) of a mobile device 20 may periodically, regularly, and/or responsive to triggers capture, measure, detect, and/or the like radio frequency signals and determine location information for the mobile device 20, respectively. Based on the output of the radio sensors and the location sensors, the mobile device 20 may generate an instance of radio observation information and an instance of location information, respectively. The instance of radio observation information and instance of location information are then bundled, combined, compressed, formatted, and/or the like into an instance of access point observation information and provided (e.g., transmitted).

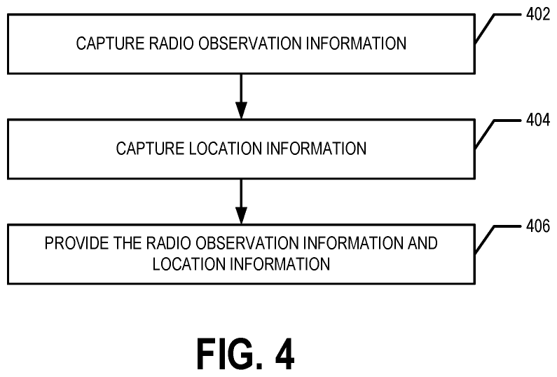

FIG. 4 provides a flowchart illustrating various processes, procedures, operations, and/or the like for providing an instance of access point observation information. Starting at block 402, a mobile device 20 captures radio observation information. For example, a mobile device 20 comprises means, such as processor 22, memory 24, sensors 29, and/or the like, for capturing radio observation information and generating an instance of radio observation information based thereon. For example, the radio sensors 29 of the mobile device 20 may observe, capture, detect, measure, and/or the like a radio frequency signal generated, broadcasted, transmitted, and/or the like by an access point 40. Based on the observation, capturing, detecting, measuring, and/or the like of the radio frequency signal, the mobile device 20 determines an access point identifier identifying the access point that generated, broadcasted, transmitted, and/or the like the radio frequency signal; a signal strength indicator configured to indicate a strength of the observed, captured, detected, measured, and/or the like radio signal; a time parameter configured to indicate a one-way or round trip time for communicating with the access point 40; a channel and/or frequency of transmission used by the access point 40; and/or the like characterizing the observation of the access point 40 by the mobile device 20. The mobile device 20 generates an instance of radio observation information comprising the access point identifier. The mobile device 20 generates the instance of radio observation information, in an example embodiment, such that the instance of radio observation information further comprises the signal strength indicator, the time parameter, and/or other information characterizing the observation of the access point 40 by the mobile device 20.

At block 404, the mobile device 20 captures location information. For example, the mobile device 20 comprises means, such as processor 22, memory 24, sensors 29, and/or the like, for capturing location information and generating an instance of location information based thereon. In an example embodiment, the location information provides an indication of the location of the mobile device 20 when the mobile device 20 observed the access point 40. For example, the location information comprises a positioning estimate (e.g., in the form of a latitude and longitude pair, and/or the like) generated using GNSS-based positioning techniques, radio-based positioning techniques, IMU-based positioning techniques, visual odometry-based positioning techniques, and/or the like, and/or a combination thereof. In various embodiments, the position estimate is a highly-accurate GNSS-based position estimate such that the position estimate that has sufficient accuracy to unambiguously indicate a road lane on which the mobile device 20 was located when the mobile device observed the access point 40. In an example embodiment, the location information comprises a direction of travel of the mobile device 20. For example, when the position estimate is not accurate enough to unambiguously indicate a road lane of which the mobile device 20 was located when the mobile device observed the access point 40, the direction of travel of the mobile device 20, onboard a vehicle 5, indicates which lane or set of lanes of a TME the mobile device 20 was traversing. In various embodiments, the direction of travel of the mobile device 20 is determined using GNSS-based techniques, radio-positioning-based techniques, IMU-based techniques, visual odometry-based techniques, a combination thereof, and/or the like. The mobile device 20 generates the instance of location information, in an example embodiment, such that the instance of location information comprises the position estimate, direction of travel, a timestamp, and/or the like corresponding to when the mobile device 20 observed the access point 40 by the mobile device.

At block 406, the mobile device 20 bundles, combines, compresses, formats, and/or the like the instance of radio observation information and the corresponding instance of location information into an instance of access point observation information and the instance of access point information is provided (e.g., transmitted). For example, the mobile device 20 comprises means, such as processor 22, memory 24, communications interface 26, and/or the like, for bundling, combining, compressing, formatting, and/or the like the instance of radio observation information and the corresponding instance of location information into an instance of access point observation information and providing the (e.g., transmitting) the instances of access point observation information. For example, the mobile device 20 may provide the instance of access point observation information via one or more wired and/or wireless networks 60 such that the network device 10 receives the instance of access point observation information.

### Exemplary Operation of a Network Device to Process Instances of Access Point Observation Information

The network device 10 receives a plurality of instances of access point observation information generated and provided by one or more respective mobile devices 20. The network device 10 process the plurality of instances of access point observation information to assign and/or associate instances of radio observation information of the plurality of instances of access point observation information to respective TMEs, lateral sides of TMEs, lateral sides of road segments, and/or the like; assign and/or associate access points identified by the instances of radio observation information to respective TMEs, lateral sides of TMEs, lateral sides of road segments, representations of buildings, and/or the like; and/or generate a traversable network-aware positioning map.

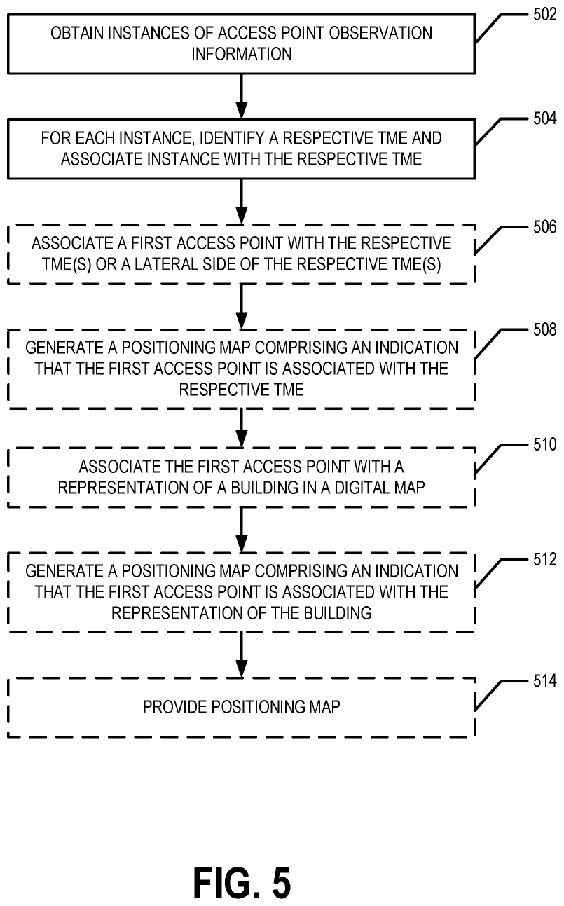

FIG. 5 provides a flowchart illustrating various processes, procedures, operations, and/or the like, performed by a network device 10, in various embodiments, to process instances of access point observation information, according to an example embodiment. Starting at block 502, the network device 10 obtains a plurality of instances of access point observation information.

Starting at block 502, a network device 10 obtains a plurality of instances of access point observation information. For example, the network device 10 comprises means, such as processor 12, memory 14, communications interface 16, user interface 18, and/or the like, for obtaining a plurality of instances of access point observation information. For example, the network device 10 may receive (e.g., via communications interface 16 and/or user interface 18) a plurality of instances of access point observation information, each instance generated by a respective one of one or more mobile devices 20. The network device 10 may directly process the plurality of instances of access point observation information upon receipt thereof (e.g., provide them directly to processor 12 for processing) or may store the plurality of instances of access point observation information (e.g., in memory 14) for accessing and/or retrieving later for processing.

Each instance of access point observation information comprises an instance of radio observation information and an instance of location information. The instance of radio observation information comprises one or more access point identifiers. Each access point identifier is configured to identify an access point that was observed by the respective mobile device 20. The instance of radio observation information further comprises information characterizing the respective observations of the one or more access points by the respective mobile device 20. For example, in an example embodiment, the instance of radio observation information comprises a signal strength indicator, a time parameter, and/or the like, each associated with a respective one of the one or more access point identifiers.

The instance of location information comprises an indication of a location of the respective mobile device when the respective mobile device 20 observed the one or more access points 40. In various embodiments, the indication of the location of the respective mobile device when the mobile device 20 observed the one or more access points 40 is provided as and/or comprises a highly-accurate global navigation satellite system (GNSS) position estimate of the location of the respective mobile device 20 when the respective mobile device 20 observed the one or more access points 40. In an example embodiment, a highly-accurate GNSS position estimate has sufficient accuracy to unambiguously indicate a road lane on which the respective mobile device 20 was located when the respective mobile device 20 observed the one or more access points 40. In various embodiments, the indication of the location of the respective mobile device when the mobile device 20 observed the one or more access points 40 is provided as and/or comprises a position estimate and a direction of movement of the respective mobile device 20 when the respective mobile device 20 observed the one or more access points 40. In various embodiments, the position estimate and/or direction of movement are determined using one or more of GNSS-based positioning techniques, radio-based positioning techniques, IMU-based positioning techniques, visual odometry positioning techniques, and/or the like.

At block 504, for one or more instance of access point observation information of the plurality of instances of access point observation information, the network device 10 identifies a TME corresponding to the location indicated by the instance of location information of the instance of access point observation information and assigns and/or associates the instance of radio observation information of the instance of access point observation information with the identified TME. For example, the network device 10 comprises means, such as processor 12, memory 14, and/or the like, for identifying a TME corresponding to the location indicated by the instance of location information of the instance of access point observation information. For example, the network device 10 comprises means, such as processor 12, memory 14, and/or the like, for associating the instance of radio observation information of the instance of access point observation information with the identified TME.

For example, the network devices stores a digital map (e.g., in memory 14) and/or otherwise has access to a digital map. Based on map data of the digital map and the position estimate, and possibly direction of travel, provided by the instance of location information, a TME of the digital map that the respective mobile device 20 was traversing when the respective mobile device 20 observed the one or more access points 40 is identified. When the position estimate has sufficient accuracy for unambiguously identifying the TME (e.g., identify the TME with a confidence level greater than a threshold confidence), the position estimate is directly map matched to a TME of the digital map to identify a TME corresponding to the instance of access point observation information. When the position estimate does not have sufficient accuracy for unambiguously identifying the TME (e.g., the TME cannot be identified with confidence level greater than the threshold confidence based on position estimate alone), the position estimate is map matched to one or more TMEs that could correspond to the position estimate. The direction of travel of the mobile device 20 provided by the instance of location information is used to identify the TME from one or more TMEs that could correspond to the position estimate. For example, TME records corresponding to respective ones of the one or more TMEs that could corresponding to the position estimate comprise travel direction information for the respective TME, in an example embodiment, that may be used to distinguish TMEs located near one another based on the direction which traffic travels along the respective TMEs. In an example embodiment, a lateral side of the TME and/or a lateral side of a road segment represented at least in part by the TME is identified. In various embodiments, the lateral side of the TME is identified based on the position estimate and/or direction of travel.

The instance of radio observation information is then assigned to and/or associated with the TME identified based on the corresponding instance of location information. For example, the instance of radio observation information may be assigned and/or associated with the identified TME, the identified lateral side of the identified TME, the identified lateral side of road segment corresponding to the identified TME, and/or the like. For example, the instance of radio observation information and/or a datastore (e.g., database) storing the instance of radio observation information may be updated, modified, and/or the like to include a TME identifier for the identified TME, a lateral side indicator, and/or the like.

At block 506, the network device 10 assigns and/or associates a first access point 40A with one or more TMEs. In an example embodiment, the network device assigns and/or associates the first access point 40A with a respective lateral side of at least one of the one or more TMEs. For example, the network device 10 comprises means, such as process 12, memory 14, and/or the like, for assigning or associating a first access point with one or more TMEs and/or a respective lateral side of at least one of the one or more TMEs.

In an example embodiment, the first access point 40A is assigned to and/or associated with the one or more TMEs along which the first access point 40A is observable (e.g., the network device 10 has received instances of access point observation information indicating that the first access point 40A has been observed by mobile devices traversing the one or more TMEs). In an example embodiment, the first access point 40A is assigned to and/or associated with one or more TMEs along which the first access point 40A is expected to be located. For example, returning to the example of FIG. 3, based on the instances of radio observation information assigned to and/or associated with the first TME 310A and the instances of radio observation information assigned to and/or associated with the second TME 310B, and possibly instances of radio observation information assigned to and/or associated with other TMEs, that the first TME 310A is located closer to first access point 40A than the second TME 310B. Thus, even though instances of radio observation information that include an access point identifier configured to identify the first access point 40A are assigned to the second TME 310B (e.g., the first access point 40A was observed by mobile devices 20 traversing the second TME 310B), the first access point 40A is assigned to and/or associated with the first TME 310A but not assigned to and/or associated with the second TME 310B, in an example embodiment.

In an example embodiment, to assign and/or associate a first access point with one or more TMEs and/or respective lateral sides of one or more TMEs, instances of radio observation information that comprise an access point identifier configured to identify the first access point 40A are identified and/or determined. For example, continuing with the example of FIG. 3, the first instance of radio observation information provided by the first mobile device 20A is associated with the first TME 310A and comprises an access point identifier configured to identify the first access point 40A. The second instance of radio observation information provided by the second mobile device 20B is associated with the second TME 310B and comprises an access point identifier configured to identify the first access point 40A. Thus, the first and second instances of radio observation information, possibly along with other instances of radio observation information comprising an access point identifier configured to identify the first access point 40A are identified, determined, and/or the like.

Based on the instances of radio observation information identified and/or determined to include an access point identifier configured to identify the first access point 40A, the first access point 40A is assigned to and/or associated with one or more TMEs, lateral sides of TMEs, lateral sides of road and/or path segments, and/or the like. For example, the instances of radio observation information identified and/or determined to include an access point identifier configured to identify the first access point 40A comprise respective measurements characterizing the respective observations of the first access point 40A by a respective mobile device (e.g., signal strength identifier, time parameter). Continuing with the example of FIG. 3, the first instances of radio observation information assigned to and/or associated with the first TME 310A comprise signal strength indicators indicating higher observed signal strengths than the second instances of radio observation information assigned to and/or associated with the second TME 310B and/or the first instances of radio observation information assigned to and/or associated with the first TME 310A comprise time parameters indicating shorter one-way and/or two way communication times with the first access point 40A than the second instances of radio observation information assigned to and/or associated with the second TME 310B. Thus, the network device 10 determines that the first access point 40A is located closer to the first TME 310A than the second TME 310B. For example, it may be determined that the first access point 40A is located on the lateral side of first TME 310A further from second TME 310B (e.g., on the right side of the first TME 310A). For example, it may be determined that the first access point 40A is located on the lateral side of the second TME 310B closer to the first TME 310A (e.g., on the left side of the second TME 310B). In another example, it may be determined that the first access point 40A is located on the lateral side of the road segment comprising the first TME 310A and the second TME 310B corresponding to the first TME 310A (e.g., the western lateral side of the road segment, when the second TME 310B has a travel direction of north).

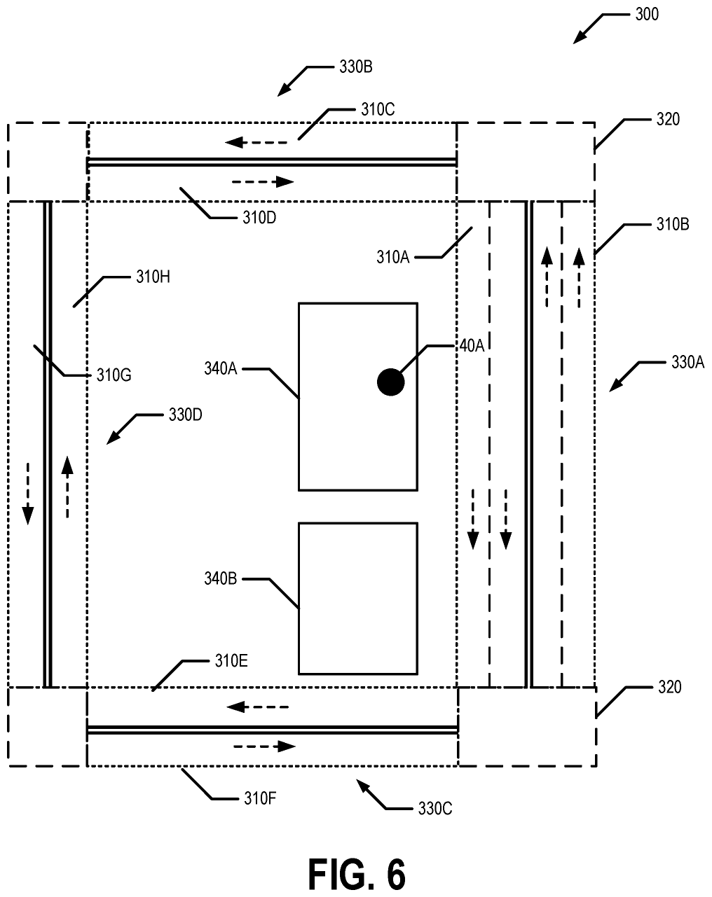

FIG. 6 provides a zoomed out view of the representation 300 of the portion of the traversable network that includes additional TMEs 310E-H. As can be seen in FIG. 6, the first TME 310A and the second TME 310B are adjacent TMEs that are complimentary (e.g., have travel directions that are in opposite directions) and that form a first road segment 330A. The third TMEs 310C and 310D are adjacent and complimentary TMEs that form a second road segment 330B. Similarly TMEs 310E and 310F are adjacent and complimentary TMEs that form third road segment 330C and TMEs 310G and 310H are adjacent and complimentary TMEs that form a fourth road segment 330D. The road segments 330A-D, formed by TMEs 310A and 310B, 310C and 310D, 310E and 310F, and 310G and 310H, respectively, enclose the representations of the buildings 340A and 340B. As should be understood, in various scenarios, a road segment 330 may be a one-directional road segment and may not include complimentary TMEs. In an example scenario, one or more instances of radio observation information that include the access point identifier configured to identify the first access point 40A are associated with respective ones of the TMEs 310A-H.

As described above, it is determined, based on the signal strength indicators and/or time parameters of the one or more instances of radio observation that include the access point identifier configured to identify the first access point 40A and that are associated with respective ones of the first TME 310A and the second TME 310B, that the first access point 40A is located on a lateral side of the first road segment 330A corresponding to the first TME 310A (and/or a lateral side of the first TME 310A that is further from the second TME 310B). Similarly, based on the signal strength indicators and/or time parameters of the one or more instances of radio observation that include the access point identifier configured to identify the first access point 40A and that are associated with respective ones of the TMEs 310C-H, it is determined that the first access point 40A is located (a) on a lateral side of the second road segment 330B corresponding to the fourth TME 310D (and/or a lateral side of the fourth TME 310D that is further from the third TME 310C), (b) on a lateral side of the third road segment 330C corresponding to TME 310E (and/or a lateral side of the TME 310E that is further from the TME 310F), and (c) on a lateral side of the fourth road segment 330D corresponding to TME 310H (and/or a lateral side of the TME 310H that is further from the TME 310G).

In other words, based on based on the signal strength indicators and/or time parameters of the one or more instances of radio observation that include the access point identifier configured to identify the first access point 40A and that are associated with respective ones of the TMEs 310A-H, it is determined that the first road segment 330A, the second road segment 330B, the third road segment 330C, and the fourth road segment 330D define and/or enclose an area within which the first access point 40A is located, in an example embodiment. Moreover, the road segments 330A-D bound the smallest area defined by the representation of the traversable network that defines and/or encloses an area within which the first access point 40A is located. For example, the representation of the traversable network does not define a TME disposed between the first and second buildings 340A, 340B that would enable the traversable network to define and/or enclose an area smaller than that defined by the road segments 330A-D. Based on these determinations, the first access point 40A is assigned to and/or associated with one or more of the road segments 330A-D, one or more of the TMEs 310A-310H (e.g., 310A, 310D, 310E, 310H), and/or respective lateral sides of one or more of the road segments 330A-D and/or TMEs 310A-310H (e.g., 310A, 310D, 310E, 310H).

For example, in an example embodiment, the first access point 40A is assigned to and/or associated with each of the road segments 330A, 330D, each of the TMEs 310A, 310D, 310E, 310H, and/or lateral sides of TMEs 310A, 310D, 310E, 310H that define and/or bound the smallest area defined by the representation of the traversable network that defines and/or encloses an area within which the first access point 40A is determined to be located. For example, in an example embodiment, even though the first access point 40A may be observed by a mobile device 20 traversing the second TME 310B or another TME a block to the right of the second TME 310B, for example, the first access point 40A is not associated with the second TME or the TME a block to the right of the second TME 310B. However, in an example embodiment, instances of radio observation information including an access point identifier configured to identify the first access point 40A may be assigned to and/or associated with the second TME 310B or the other TME a block to the right of the second TME 310B based on the respective corresponding instance of location information.

Continuing with FIG. 5, at block 508, a traversable network-aware positioning map is generated. For example, the network device 10 comprises means, such as processor 12, memory 14, and/or the like, for generating a traversable network-aware positioning map. For example, the traversable network aware-positioning map comprises an indication of the first access point 40A (and possibly other access points) being assigned to and/or associated with one or more respective TMEs and/or respective lateral sides of one or more respective TMEs. In an example embodiment, generating the traversable network-aware positioning map comprises creating the traversable network-aware positioning map, possibly based on an existing representation of a traversable network. For example, the traversable network-aware positioning map may be a digital map that provides a representation of at least a portion of the traversable network (e.g., comprises a traversable network layer) and that comprises an access point layer and/or other formatting of information regarding one or more access points 40 that are assigned to and/or associated with respective road segments, respective TMEs, respective lateral sides of respective TMEs of the representation of the at least a portion of the traversable network. In an example embodiment, generating the traversable network-aware positioning map comprises updating a traversable network-aware positioning map to include information/data regarding the first access point 40A, the assignment and/or association of the first access point 40A with one or more respective TMEs and/or respective lateral sides of one or more respective TMEs, modifying information/data already included in the traversable network-aware positioning map corresponding to the first access point 40A and/or the assignment and/or association of the first access point 40A to one or more respective TMEs and/or respective lateral sides of one or more respective TMEs, and/or the like.

For example, based on the instances of radio observation information including an access point identifier configured to identify the first access point 40A and the TMEs to which such instances of radio observation information are assigned to and/or associated with, a radio model encoding and/or describing the broadcast and/or coverage area of the first access point 40A. In various embodiments, the broadcast and/or coverage area of the first access point 40A is the area within which the first access point 40A is observable with an observed signal strength greater than a threshold signal strength. In an example embodiment, the threshold signal strength is a minimum, maximum, and/or average threshold of detectability characterizing the radio sensors 29 of a population of mobile devices 20. For example, the radio model for the first access point may comprise information regarding expected signal strengths and/or time parameters observable for the first access point 40A by mobile devices 20 traversing respective TMEs within the broadcast and/or coverage area of the first access point 40A. The radio model for the first access point 40A may be stored to the traversable network-aware positioning map.

At block 510, the network device 10 assigns and/or associates the first access point 40A with a representation of a building in a digital map. For example, the network device 10 comprises means, such as processor 12, memory 14, and/or the like, for assigning and/or associating the first access point with a representation of a building in a digital map. In various embodiments, the building is a building within which the first access point 40A is expected to be located. In various embodiments, the digital map provides a representation of at least a portion of the traversable network (e.g., representation 300) and representations of one or more buildings (e.g., representations of buildings 340A, 340B) located at various locations within the traversable network.

As described above, an area (e.g., the smallest area) defined by the representation of the traversable network within which the first access point 40A is located may be determined by the network device 10. If only one representation of a building is located within that determined area, the first access point 40A is assigned to and/or associate with the representation of that one building. If two or more representations of buildings are located within that determined area, one of the representations is selected based on the instances of radio observation information including an access point identifier configured to identify the first access point 40A and the respective TMEs and/or respective lateral sides of respective TMEs to which the instances of radio observation information are assigned and/or associated. For example, in the example of FIG. 6, the representation of the first building 340A and the representation of the second building 340B are both located within the area defined by the TMEs 310A, 310D, 310H, and 310E determined to contain the location of the first access point 40A. Based on the signal strength indicators and/or time parameters of instances of radio observation information assigned to TMEs 310C-F, it may be determined that the first access point 40A is located closer to the TMEs 310C, 310D than the TMEs 310E, 310F. Therefore, the first access point 40A is assigned to and/or associated with the representation of a building that is located closer to the TMEs 310C, 310D than to TMEs 310E, 310F (e.g., the representation of the first building 340A), in an example embodiment. A similar approach may be used if there are representations of more than two buildings located within the determined area (e.g., the smallest area) defined by the representation of the traversable network within which the first access point 40A is located to estimate and/or determine the building with within which the first access point 40A is located.

At block 512 of FIG. 5, a traversable network-aware positioning map comprising information/data regarding the assignment and/or association of the first access point 40A to a representation of a building is generated. For example, the network device 10 comprises means, such as processor 12, memory 14, and/or the like, for generating a traversable network-aware positioning map comprising information/data regarding the assignment and/or association of the first access point 40A to a representation of a building. For example, the traversable network aware-positioning map comprises an indication of the first access point 40A (and possibly other access points) being assigned to and/or associated with representations of respective buildings.

In an example embodiment, generating the traversable network-aware positioning map comprises creating the traversable network-aware positioning map, possibly based on an existing representation of a traversable network comprising representations of one or more buildings. For example, the traversable network-aware positioning map may be a digital map that provides representations of one or more buildings located at various locations within at least a portion of a traversable network (e.g., comprises a building representation layer) and that comprises an access point layer and/or other formatting of information regarding one or more access points 40 that are assigned to and/or associated with representations of respective buildings provided by the digital map. In an example embodiment, generating the traversable network-aware positioning map comprises updating a traversable network-aware positioning map to include information/data regarding the first access point 40A, the assignment and/or association of the first access point 40A with a representation of a building, modifying information/data already included in the traversable network-aware positioning map corresponding to the first access point 40A and/or the assignment and/or association of the first access point 40A to a representation of a building, and/or the like.

At block 514, the network device 10 provides at least a portion of the traversable network-aware positioning map. For example, the network device 10 comprises means, such as processor 12, memory 14, communications interface 16, user interface 18, and/or the like, for providing at least a portion of the traversable network-aware positioning map (e.g., a tile of the traversable network-aware positioning map. As described above, the traversable network-aware positioning map comprises information/data regarding the assignment and/or association of at least one access point 40 with at least one respective road/path segment, respective TME, and/or respective lateral side of at least one respective TME and/or road/path segment. In an example embodiment, the traversable network-aware positioning map further comprises information/data regarding the assignment and/or association of at least one access point 40 with a representation of a respective building located within the traversable network. In an example embodiment, the network device 10 provides (e.g., transmits) at least a portion of the traversable network-aware positioning map such that one or more other network devices 10 and/or computing entities 30 receive the at least a portion of the traversable network-aware positioning map. The network devices 10 and/or computing entities 30 may then use the at least a portion of the traversable network-aware positioning map to perform radio-based positioning (e.g., determine a position estimate for a computing entity 30 based on radio sensor data captured by the computing entity 30) and/or to perform one or more positioning and/or navigation-related functions. In an example embodiment, the network device 10 stores the at least a portion of the traversable network-aware positioning map in memory (e.g., memory 14) such that the network device 10 can use the at least a portion of the traversable network-aware positioning map to perform radio-based positioning (e.g., determine a position estimate for a computing entity 30 based on radio sensor data captured by the computing entity 30) and/or to perform one or more positioning and/or navigation-related functions.

In various embodiments, one or more steps, operations, processes, procedures, and/or the like described herein as being performed by the network device 10 are performed by a mobile device 20. For example, in an example embodiment, a mobile device 20 assigns and/or associates an instance of radio observation information generated by the mobile device 20 with a road segment, TME, lateral side of a TME, and/or the like.

### Exemplary Operation of a Computing Entity

In various embodiments, positioning for a computing device 30 and/or one or more positioning and/or navigation-related functions corresponding to the computing device 30 are performed by a network device 10 and/or the computing device 30 using a traversable network-aware positioning map. For example, a computing device 30 which may or may not be onboard a vehicle 5 (e.g., may be physically associated with a pedestrian) may be located within a geographic area associated with a traversable network. For example, the computing device 30 may be onboard a vehicle 5 traversing at least a portion of the traversable network, in the pocket and/or hand of a pedestrian walking along a sidewalk and/or path, located in a geographic area associated with the traversable network, and/or the like. The computing device 30 may capture, generate, and/or determine an instance of radio detection information.

In various embodiments, an instance of radio detection information comprises a respective access point identifier for each of one or more access points observed by the computing device 30. In various embodiments, a computing device 30 observes an access point by receiving, detecting, capturing, measuring, and/or the like a signal (e.g., a radio frequency signal) generated by the access point. For example, a computing device 30 may determine an access point identifier, a received signal strength, a one-way or round trip time for communicating with the access point, a channel or frequency of the access point, and/or the like based on the computing device's observation of the access point.

In various embodiments, an instance of radio detection information further includes one or more measurements characterizing the observation of an access point 40 by the computing device 30. For example, when the computing device 30 observes a first access point 40A, the instance of radio detection information comprises an access point identifier configured to identify the first access point 40A and one or more measurement values such as the signal strength indicator configured to indicate an observed signal strength of the observed radio frequency signal generated, broadcasted, transmitted, and/or the like by the first access point 40A; a one way or round trip time value for communication (one way or two way communication) between the first access point 40A and the computing device 30; a channel and/or frequency of transmission used by the first access point 40A; and/or the like characterizing the observation of the first access point 40A by the computing device 30.

The computing device 30 provides the instance of radio detection information to a positioning function operating on the computing device 30 and/or a network device 10. In various embodiments, the positioning function (operating on the computing device 30 and/or the network device 10) uses the instance of radio detection information and a traversable network-aware positioning map to determine a position estimate for the location of the computing device 30 when the computing device 30 generated, captured, determined, and/or the like the instance of radio detection information. The position estimate and the traversable network-aware positioning map may then be used (e.g., by the computing device 30 and/or network device 10) to perform one or more positioning and/or navigation-related functions.

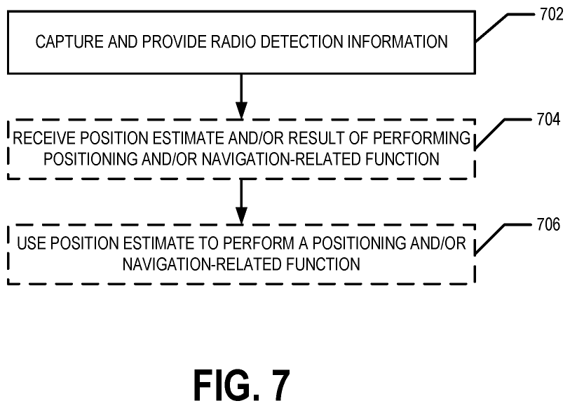

FIG. 7 provides a flowchart illustrating various processes, procedures, operations, and/or the like performed by a computing device 30 in conjunction with various embodiments. Starting at block 702, the computing device 30 captures, determines, and/or generates an instance of radio detection information and provide the instance of radio detection information. For example, the computing device 30 comprises means, such as processor 32, memory 34, communications interface 36, sensors 39, and/or the like, for capturing, determining, and/or generating an instance of radio detection information and providing the instance of radio detection information. For example, the sensors 39 of the computing device 30 observe and/or detect radio frequency signals generated by one or more access points and information/data, measurements, and/or the like characterizing the observation and/or detection of the radio frequency signals is incorporated into an instance of radio detection information. The instance of radio detection information is then provided to a positioning function operating on the computing device 30 and/or a network device 10 via an application program interface (API) call, for example. When the positioning function is operating on the network device 10, providing the instance of radio detection information to the positioning function includes transmitting the instance of radio detection information such that the network device 10 receives the instance of radio detection information. The positioning function is configured to use the instance of radio detection information and a traversable network-aware positioning map to determine a position estimate for the location of the computing device 30 when the computing device 30 observed and/or detected the one or more radio frequency signals the observation and/or detection of which are characterized by the instance of radio detection information.

At block 704, in an example embodiment, the computing device 30 receives a position estimate generated based on the instance of radio detection information and the traversable network-aware positioning map. For example, the computing device 30 comprises means, such as processor 32, memory 34, communications interface 36, and/or the like, for receiving a position estimate generated and/or determined by the positioning function based on the instance of radio detection information and the traversable network-aware positioning map. In an example embodiment, the network device 30 generates and/or determines the position estimate and uses the position estimate (and possibly the traversable network-aware positioning map) to perform a positioning and/or navigation-related function. The network device 10 may then provide (e.g., transmit) the position estimate and/or a result of the positioning and/or navigation-related function such that the computing device 30 receives the position estimate and/or the result of the positioning and/or navigation-related function. Some non-limiting examples of positioning and/or navigation-related functions include providing a route or information corresponding to a geographic area (e.g., via a user interface), localization, localization visualization, route determination, lane level route determination, operating a vehicle along at least a portion of a route, operating a vehicle along at least a portion of a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, and/or the like.

At block 706, in an example embodiment, the computing device 30 performs one or more positioning and/or navigation-related functions based on the position estimate and, possibly, a traversable network-aware positioning map. For example, the computing device 30 comprises means, such as processor 32, memory 34, communications interface 36, user interface 38, and/or the like, for performing one or more positioning and/or navigation-related functions based on the position estimate and, possibly, the traversable network-aware positioning map. For example, the computing device 30 may display the position estimate on a representation of the traversable network via the user interface 38 of the computing device 30 and/or perform various other positioning and/or navigation-related functions based at least in part on the position estimate.

### Exemplary Operation of a Network Device to Determine a Position Estimate

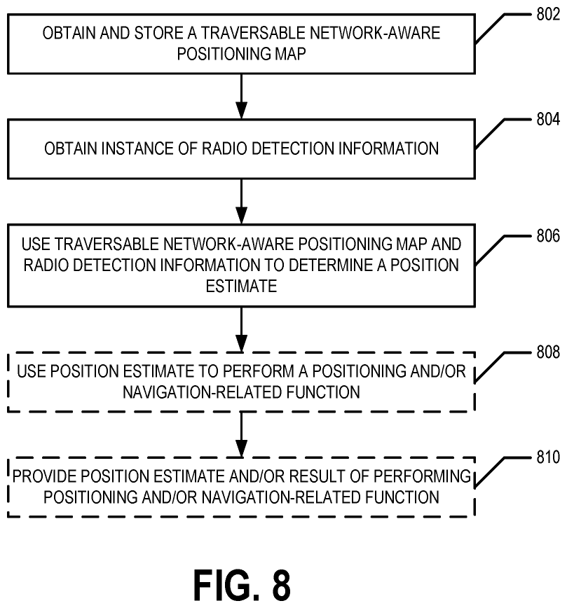

FIG. 8 provides a flowchart illustrating various processes, procedures, operations, and/or the like performed by a network device 10 to determine a position estimate for a computing device 30 using a traversable network-aware positioning map. In various embodiments, one or more of the processes, procedures, operations, and/or the like illustrated in FIG. 8 is performed by a computing device 30. For example, in an example embodiment, the computing device stores a traversable network-aware positioning map and uses the traversable network-aware positioning map to determine and/or generate a position estimate.

Starting at block 802, the network device 10 obtains and stores a traversable network-aware positioning map. For example, the network device 10 comprises means, such as processor 12, memory 14, communications interface 16, and/or the like, for obtaining and storing a traversable network-aware positioning map. In an example embodiment, the network device 10 generates the traversable network-aware positioning map (e.g., in a manner similar to that described with respect to FIG. 5) and stores the traversable network-aware positioning map in memory 14 and/or another memory accessible to the processor 12. In an example embodiment, the network device 10 receives the traversable network-aware positioning map via the communications interface 16 and stores the traversable network-aware positioning map in memory 14 and/or another memory accessible to the processor 12.

At block 804, the network device 10 obtains an instance of radio detection information. For example, the network device 10 comprises means, such as processor 12, memory 14, communications interface 16, and/or the like, for obtaining an instance of radio detection information. For example, a computing device 30 may capture, generate, determine, and/or the like an instance of radio detection information and provide (e.g., transmit) the instance of radio detection information such that the network device 10 receives the instance of radio detection information, as described with respect to FIG. 8. In an example embodiment, the network device 10 may access the instance of radio detection information.

In various embodiments, an instance of radio detection information comprises a respective access point identifier for each of one or more access points observed by the computing device 30. In various embodiments, an instance of radio detection information further includes one or more measurements characterizing the observation of the one or more access points 40 by the computing device 30. For example, when the computing device 30 observes a first access point 40A, the instance of radio detection information comprises an access point identifier configured to identify the first access point 40A and one or more measurement values such as the signal strength indicator configured to indicate an observed signal strength of the observed radio frequency signal generated, broadcasted, transmitted, and/or the like by the first access point 40A; a one way or round trip time value for communication (one way or two way communication) between the first access point 40A and the computing device 30; a channel and/or frequency of transmission used by the first access point 40A; and/or the like characterizing the observation of the first access point 40A by the computing device 30.

At block 806, the network device 10 determines and/or generates a position estimate based on the instance of radio detection information and the traversable network-aware positioning map. For example, the network device 10 comprises means, such as processor 12, memory 14, and/or the like, for determining and/or generating a position estimate based on the instance of radio detection information and the traversable network-aware positioning map. For example, in an example embodiment, the memory 14 stores program code and/or instructions which, when executed by the processor 12, provides a positioning function configured to determine and/or generate a position estimate based on the instance of radio detection information and the traversable network-aware positioning map. For example, based on the access point identifiers, corresponding signal strength indicators, and/or time parameters provided by the instance of radio detection information and the access point layer, for example, of the traversable network-aware positioning map, the positioning function determines and/or generates a position estimate for the computing device 30 when the computing device observed the one or more access points indicated in the instance of radio detection information.

At block 808, in an example embodiment, the network device 10 performs one or more positioning and/or navigation-related functions based on the position estimate and, possibly, a traversable network-aware positioning map. For example, the network device 10 comprises means, such as processor 12, memory 14, and/or the like, for performing one or more positioning and/or navigation-related functions based on the position estimate and, possibly, the traversable network-aware positioning map. For example, the network device 10 may determine a route for the computing device 30 based on the position estimate and the traversable network-aware positioning map and/or perform various other positioning and/or navigation-related functions based at least in part on the position estimate.

At block 810, in an example embodiment, the network device 10 provides the position estimate and/or a result of performing one or more positioning and/or navigation-related functions based on the position estimate. For example, the network device 10 comprises means, such as processor 12, memory 14, communications interface 16, and/or the like for providing (e.g., transmitting) the position estimate and/or a result of performing one or more positioning and/or navigation-related functions based on the position estimate. For example, in an example embodiment, the network device 10 provides the position estimate and/or result of performing one or more positioning and/or navigation-related functions such that the computing device 30 receives the position estimate and/or a result of performing one or more positioning and/or navigation-related functions.

### III. Technical Advantages

Various embodiments provide technical solutions to the technical problems of determining a location of an access point when information regarding the location of the access point is not directly available. For example, by collecting and processing instances of access point observation information that each include an instance of radio observation information characterizing the observation of one or more access points by a mobile device and an instance of location information indicating a location (and possibly direction of travel) of the mobile device when the mobile device observed the one or more access points, the location of the access point and/or a radio model for the access point may be determined. Moreover, the instance of location information may include a GNSS-based position estimate and/or location of travel that enables the corresponding instance of radio observation information to be map-matched to a TME (e.g., a representation of one or more (adjacent) travel lanes of a road/path segment), such that the location of the access point may be accurately determined and/or the characteristics of radio frequency signals generated, broadcasted, and/or transmitted by the access point across the broadcast and/or coverage area of the access point may be accurately associated with locations within a geographic region corresponding to the traversable network. For example, various embodiments provide the technical advantage of being able to determine along which TMEs and/or one which lateral side of TMEs an access point is located.

In various embodiments, the technical solutions provided include the generation, provision, and usage of traversable network-aware positioning maps. For example, in various embodiments, traversable network-aware positioning maps may be generated, provided, and/or used that associate access points and/or characterizations of radio frequency signals generated by one or more access points with one or more respective TMEs and/or a respective lateral side of one or more respective TMEs and/or that associate access points with representations of respective buildings within which the access point is expected to be located. For example, various embodiments provide the technical advantage of providing a digital map (a traversable network-aware positioning map) that may be used for both route determination along portions of a traversable network and radio-based positioning of computing devices located in the geographic region corresponding to the traversable network.

### IV. Example Apparatus

The network device 10, mobile device 20, and/or computing device 30 of an example embodiment may be embodied by or associated with a variety of computing devices including, for example, a navigation system including a global navigation satellite system (GNSS), a cellular telephone, a mobile phone, a personal digital assistant (PDA), a watch, a camera, a computer, an Internet of things (IoT) item, and/or other device that can observe the radio environment (e.g., receive radio frequency signals from network access points) in the vicinity of the computing device and/or that can store at least a portion of a positioning map. Additionally or alternatively, the network device 10, mobile device 20, and/or computing device 30 may be embodied in other types of computing devices, such as a server, a personal computer, a computer workstation, a laptop computer, a plurality of networked computing devices or the like, that are configured to capture and provide audio samples, train a classification engine, execute a classification engine taking an audio sample as input, execute a crowd-sourcing or positioning process, and/or the like. In an example embodiment, a mobile device 20 and/or a computing device 30 is a smartphone, tablet, laptop, PDA, and/or other mobile computing device and a network device 10 is a server that may be part of a Cloud-based computing asset and/or processing system.

In some embodiments, the processor 12, 22, 32 (and/or co-processors or any other processing circuitry assisting or otherwise associated with the processor) may be in communication with the memory device 14, 24, 34 via a bus for passing information among components of the apparatus. The memory device may be non-transitory and may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the network device 10, mobile device 20, and/or computing device 30 may be embodied by a computing entity and/or device. However, in some embodiments, the network device 10, mobile device 20, and/or computing device 30 may be embodied as a chip or chip set. In other words, the network device 10, mobile device 20, and/or computing device 30 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22, 32 may be embodied in a number of different ways. For example, the processor 12, 22, 32 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 12, 22, 32 may include one or more processing cores configured to perform independently. A multi-core processor may enable multiprocessing within a single physical package. Additionally or alternatively, the processor 12, 22, 32 may include one or more processors configured in tandem via the bus to enable independent execution of instructions, pipelining and/or multithreading.

In an example embodiment, the processor 12, 22, 32 may be configured to execute instructions stored in the memory device 14, 24, 34 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the network device 10, mobile device 20, and/or computing device 30 may include a user interface 18, 28, 38 that may, in turn, be in communication with the processor 12, 22, 32 to provide output to the user, such as one or more navigable routes to a destination location and/or from an origin location, display of location dependent and/or triggered information, and/or the like, and, in some embodiments, to receive an indication of a user input. As such, the user interface 18, 28, 38 may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 12, 22, 32 (e.g., memory device 14, 24, 34 and/or the like).

The network device 10, mobile device 20, and/or computing device 30 may optionally include a communication interface 16, 26, 36. The communication interface 16, 26, 36 may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In various embodiments, a network device 10, mobile device 20, and/or computing device 30 may comprise a component (e.g., memory 14, 24, 34, and/or another component) that stores a digital map (e.g., in the form of a geographic database) comprising a first plurality of data records, each of the first plurality of data records representing a corresponding traversable map element (TME). At least some of said first plurality of data records map information/data indicate current traffic conditions along the corresponding TME. For example, the geographic database may include a variety of data (e.g., map information/data) utilized in various navigation functions such as constructing a route or navigation path, determining the time to traverse the route or navigation path, matching a geolocation (e.g., a GNSS determined location, a radio-based position estimate) to a point on a map, a lane of a lane network, and/or link, one or more localization features and a corresponding location of each localization feature, and/or the like. For example, the geographic database may comprise a positioning map comprising an access point registry and/or instances of network access point information corresponding to various network access points. For example, a geographic database may include road segment, segment, link, lane segment, or TME data records, point of interest (POI) data records, localization feature data records, and other data records. More, fewer or different data records can be provided. In one embodiment, the other data records include cartographic (“cartel”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, POI data records, and/or other data records. In an example embodiment, the network device 10 may be configured to modify, update, and/or the like one or more data records of the geographic database. For example, the network device 10 may modify, update, generate, and/or the like map information/data corresponding to TMEs, links, lanes, road segments, travel lanes of road segments, nodes, intersection, pedestrian walkways, elevators, staircases, and/or the like and/or the corresponding data records (e.g., to add or update updated map information/data including, for example, current traffic conditions along a corresponding TME; assign and/or associate an access point with a TME, lateral side of a TME, and/or representation of a building; and/or the like), a localization layer (e.g., comprising localization features), a registry of access points to identify mobile access points, and/or the corresponding data records, and/or the like.

In an example embodiment, the TME data records are links, lanes, or segments (e.g., maneuvers of a maneuver graph, representing roads, travel lanes of roads, streets, paths, navigable aerial route segments, and/or the like as can be used in the calculated route or recorded route information for determination of one or more personalized routes). The intersection data records are ending points corresponding to the respective links, lanes, or segments of the TME data records. The TME data records and the intersection data records represent a road network and/or other traversable network, such as used by vehicles, cars, bicycles, and/or other entities. Alternatively, the geographic database can contain path segment and intersection data records or nodes and connection information/data or other data that represent pedestrian paths or areas in addition to or instead of the vehicle road record data, for example. Alternatively and/or additionally, the geographic database can contain navigable aerial route segments or nodes and connection information/data or other data that represent an navigable aerial network, for example.

The TMEs, lane/road/link/path segments, segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

### V. Apparatus, Methods, and Computer Program Products

As described above, FIGS. 4, 5, 7, and 8 illustrate flowcharts of a network device 10, mobile device 20, and/or computing device 30, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24, 34 of an apparatus employing an embodiment of the present invention and executed by the processor 12, 22, 32 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
obtaining, by at least one processor, a plurality of instances of access point observation information, each instance of access point observation information comprising (a) an instance of radio observation information corresponding to observation of one or more access points by a respective mobile device and (b) an instance of location information comprising an indication of a location of the respective mobile device when the respective mobile device observed the one or more access points; and
for one or more instances of the plurality of instances of access point observation information:
based at least on the instance of location information of the instance of access point observation information and a digital map that is accessible to the at least one processor, identifying, by the at least one processor, a respective traversable map element (TME) of the digital map that represents a portion of a traversable network where the mobile device was located when the mobile device observed the one or more access points; and
associating, by the at least one processor, at least a portion of the instance of radio observation information with the respective TME.

2. The method of claim 1, wherein identifying the respective TME comprises, based at least in part on the location information of the instance and the digital map, determining a lateral side of the portion of the traversable network where the mobile device was located when the mobile device observed the one or more access points, wherein associating the at least a portion of the instance of radio observation information with the respective TME comprises associating the at least a portion of the instance of radio observation information with the lateral side of the respective TME.

3. The method of claim 1, wherein the instance of location information comprises a highly-accurate global navigation satellite system (GNSS) position estimate of the location of the respective mobile devices when the respective mobile device observed the one or more access points.

4. The method of claim 3, wherein the highly-accurate GNSS position estimate has sufficient accuracy to unambiguously indicate a road lane on which the mobile device was located when the location information was captured.

5. The method of claim 1, wherein the instance of location information comprises a position estimate and a direction of movement of the respective mobile device when the respective mobile device observed the one or more access points.

6. The method of claim 5, wherein at least one of the respective TME or a lateral side of the respective TME is identified based at least on the direction of movement and a directionality of the respective TME or lateral side of the TME indicated by map data of the digital map.

7. The method of claim 1, wherein the instance of radio observation information comprises, for each access point of the one or more access points (a) an access point identifier configured to identify the access point and (b) a signal strength indicator corresponding to the observed signal strength of the access point.

8. The method of claim 7, further comprising associating a first access point of the one or more access points with at least one TME based at least in part on the signal strength indicator of one or more instances of access point observation information and the respective TME associated with the one or more instances of access point observation information.

9. The method of claim 8, further comprising providing an indication of the first access point being associated with the at least one TME such that a computing device receives the indication, the computing device configured to perform a positioning and/or navigation-related function based at least in part on the indication of the first access point being associated with the at least one TME.

10. The method of claim 8, further comprising generating a positioning map comprising information corresponding to the first access point associated with the at least one TME.

11. The method of claim 1 further comprising:
based at least on one or more instances of access point observation information associated with a first access point and respective TMEs associated with the at least a portion of the instance of radio observation information of the one or more instances of access point observation information, determining a building in which the first access point of the one or more access points is located, wherein the digital map comprises a representation of the building; and
associating the first access point with the representation of the building.

12. The method of claim 11, wherein the building is selected from two or more buildings located along the respective TME based at least in part on a signal strength indicator associated with the first access point in the one or more instances of access point observation information.

13. The method of claim 11, further comprising generating a positioning map comprising information corresponding to the first access point associated with a representation of the building.

14. A method comprising:
obtaining, by at least one processor, an instance of radio detection information corresponding to observation of one or more access points by a computing device;
based at least on the instance of radio detection information and positioning map information accessible to the at least one processor, determining, by the at least one processor, a position estimate for the computing device, wherein the positioning map comprises a plurality of instances of access point information, wherein each instance of access point information is associated with at least one traversable map element (TME) of a digital map.

15. The method of claim 14, further comprising performing at least one positioning and/or navigation-related function based at least in part on the position estimate.

16. The method of claim 14, wherein at least one instance of access point information is associated with a representation of a building in the digital map.

17. The method of claim 14, wherein at least one instance of access point information is associated with a lateral side of the at least one TME.

18. An apparatus comprising at least one processor and at least one memory storing computer program instructions, the at least one memory and the computer program code are configured to, with the processor, cause the apparatus to at least:
obtain a plurality of instances of access point observation information, each instance of access point observation information comprising (a) an instance of radio observation information corresponding to observation of one or more access points by a respective mobile device and (b) an instance of location information comprising an indication of a location of the respective mobile device when the respective mobile device observed the one or more access points; and
for one or more instances of the plurality of instances of access point observation information:
based at least on the instance of location information of the instance of access point observation information and a digital map that is accessible to the at least one processor, identify a respective traversable map element (TME) of the digital map that represents a portion of a traversable network where the mobile device was located when the mobile device observed the one or more access points; and
associate at least a portion of the instance of radio observation information with the respective TME.

19. The apparatus of claim 18, wherein the instance of location information comprises (a) a highly-accurate global navigation satellite system (GNSS) position estimate of the location of the respective mobile devices when the respective mobile device observed the one or more access points or (b) a position estimate and a direction of movement of the respective mobile device when the respective mobile device observed the one or more access points.

20. The apparatus of claim 18, wherein the at least one memory and the computer program code are further configured to, with the processor, cause the apparatus to at least:
based at least on one or more instances of access point observation information associated with a first access point and respective TMEs associated with the at least a portion of the instance of radio observation information of the one or more instances of access point observation information, determine a building in which the first access point of the one or more access points is located, wherein the digital map comprises a representation of the building; and
associate the first access point with the representation of the building.
